(19) United States
(12) Patent Application Publication
(10) Pub. No.: US 2026/0186357 A1
(43) Pub. Date: Jul. 2, 2026

(54) DISPLAY SUBSTRATE, DISPLAY PANEL AND DISPLAY APPARATUS

(71) Applicants: Beijing BOE Technology Development Co., Ltd., Beijing (CN); BOE Technology Group Co., Ltd., Beijing (CN)

(72) Inventors: Lizhong WANG, Beijing (CN); Ce NING, Beijing (CN); Wei YANG, Beijing (CN)

(21) Appl. No.: 18/727,641

(22) PCT Filed: Apr. 20, 2023
(86) PCT No.: PCT/CN2023/089601

§ 371 Date: Jul. 9, 2024

(51) Int. Cl. G02F 1/1362; G02F 1/1368

(52) U.S. Cl. CPC G02F 1/136222; G02F 1/136209; G02F 1/1368

(57) ABSTRACT

Provided are a display substrate, display panel and display apparatus. The display substrate includes: a base substrate; a plurality of sub-pixels on a side of the base substrate, where each of the plurality of sub-pixels includes a sub-pixel opening region; an inorganic color-resist layer, on the same side as the plurality of sub-pixels, including a plurality of color-resist units, where an orthographic projection of the color-resist unit on the base substrate covers an orthographic projection of the sub-pixel opening region, and a light emitting color of the color-resist unit is same as a color of its corresponding sub-pixel; the color-resist unit includes at least two inorganic sub-layers stacked alternately, and different inorganic sub-layers have different refractive indexes.

### CROSS REFERENCE TO RELATED APPLICATIONS

The present disclosure is a US National Stage of International Application No. PCT/CN2023/089601, filed on Apr. 20, 2023, the entire contents of which are incorporated herein by reference.

### TECHNICAL FIELD

The present disclosure relates to the field of display technology, and in particular to a display substrate, display panel and display apparatus.

### BACKGROUND

Liquid crystal display products need to use a color film to achieve full-color display. The color film used in traditional liquid crystal display products is an absorbent color film, and about ⅔ of the energy is lost after the light passes through the color film, which affects the light utilization rate of the display products.

### SUMMARY

Embodiments of the present disclosure provide a display substrate. The display substrate includes:
a base substrate;
a plurality of sub-pixels, located on a side of the base substrate; where each of the plurality of sub-pixels includes a sub-pixel opening region; and
an inorganic color-resist layer, located on a same side of the base substrate as the plurality of sub-pixels and including a plurality of color-resist units; where an orthographic projection of a color-resist unit on the base substrate covers an orthographic projection of the sub-pixel opening region on the base substrate, the plurality of color-resist units includes: a first color-resist unit, a second color-resist unit and a third color-resist unit, at least two of the first color-resist unit, the second color-resist unit, and the third color-resist unit have different light emitting colors; and the color-resist unit includes at least two inorganic sub-layers that are stacked alternately, a quantity of inorganic sub-layers included in color-resist units with different light emitting colors varies, and refractive indexes of two adjacent inorganic sub-layers are different.

In some embodiments, at least two of the first color-resist unit, the second color-resist unit and the third color-resist unit have different thicknesses in a direction perpendicular to the base substrate.

In some embodiments, a difference in thicknesses of different color-resist units in the direction perpendicular to the base substrate is less than or equal to 1 micron.

In some embodiments, the color-resist unit includes a first portion; and first portions of different color-resist units are provided independently with each other.

In some embodiments, an absolute value of a distance between first portions of different color-resist units adjacent to each other is less than or equal to 10 microns.

In some embodiments, the absolute value of the distance between first portions of different color-resist units adjacent to each other is less than or equal to 3 microns.

In some embodiments, the color-resist unit further includes a second portion located at a side of the first portion facing away from the base substrate, and second portions of the plurality of color-resist units are integrally connected.

In some embodiments, first portions of at least two of the first color-resist unit, the second color-resist unit and the third color-resist unit have different thicknesses in the direction perpendicular to the base substrate.

In some embodiments, the display substrate further includes: a first light-shielding part, located between the first portion and the base substrate; where an orthographic projection of the first light-shielding part on the base substrate covers an region between orthographic projections of adjacent first portions on the base substrate, and the orthographic projection of the first light-shielding part on the base substrate does not overlap the sub-pixel opening region.

In some embodiments, a lateral surface of the first portion includes an inclined surface, and an included angle between the inclined surface and a plane where the base substrate is located is greater than or equal to 60° and less than 90°.

In some embodiments, an absolute value of a minimum distance between inclined surfaces of two adjacent first portions is less than or equal to 5 microns.

In some embodiments, in a region between adjacent sub-pixel opening regions, orthographic projections of adjacent first portions on the base substrate have an overlap; and an orthographic projection of the first portion on the base substrate does not overlap an orthographic projection, on the base substrate, of a sub-pixel opening region corresponding to an adjacent first portion of the first portion.

In some embodiments, an orthographic projection of any first portion on the base substrate covers an orthographic projection of a region between adjacent sub-pixel opening regions on the base substrate;
the inorganic color-resist layer further includes a superposition portion; where an orthographic projection of the superposition portion on the base substrate covers the orthographic projection of the region between adjacent sub-pixel opening regions on the base substrate, and the orthographic projection of the superposition portion on the base substrate and the orthographic projection of the sub-pixel opening region on the base substrate do not overlap each other; and
between the adjacent sub-pixel opening regions, the orthographic projection of the color-resist unit on the base substrate and the orthographic projection of the superposition portion on the base substrate have an overlapping region in which a light transmittance is less than 5%.

In some embodiments, a surface of the first portion on a side away from the base substrate includes a first planar region, and an orthographic projection of the first planar region on the base substrate covers the sub-pixel opening region.

In some embodiments, the color-resist unit includes a first inorganic sub-layer and a second inorganic sub-layer; where a refractive index of the first inorganic sub-layer is greater than a refractive index of the second inorganic sub-layer; and an inorganic sub-layer closest to the base substrate is the first inorganic sub-layer.

In some embodiments, a material of the first inorganic sub-layer includes one or a combination of following: silicon nitride, titanium dioxide, titanium pentoxide, niobium pentoxide, zirconium dioxide, yttrium trioxide, and zinc sulfide; and
a material of the second inorganic sub-layer includes one or a combination of following: silicon oxide, and magnesium fluoride.

In some embodiments, the sub-pixel includes: a thin-film transistor, and a pixel electrode located at a side of the thin-film transistor facing away from the base substrate.

In some embodiments, the inorganic color-resist layer is located between the base substrate and the plurality of sub-pixels;
the display substrate further includes: a first planarization layer located between the inorganic color-resist layer and the plurality of sub-pixels.

In some embodiments, a material of the first planarization layer includes organic silicone.

In some embodiments, the inorganic color-resist layer is located between the thin film transistor and the pixel electrode.

In some embodiments, the thin film transistor includes: a gate, a source and a drain;
the display panel further includes: a first inorganic insulation layer between the gate and the source and drain, and a second planarization layer between the source and drain and the pixel electrode; and
the inorganic color-resist layer is located between the first inorganic insulation layer and the second planarization layer.

In some embodiments, a material of the second planarization layer includes a resin.

In some embodiments, the inorganic color-resist layer is located at one sides of the plurality of sub-pixels facing away from the base substrate.

In some embodiments, each sub-pixel includes a light-emitting device; and the inorganic color-resist layer is located at a side of the light-emitting device facing away from the base substrate.

In some embodiments, the plurality of color-resist units and the plurality of sub-pixels are in one-to-one correspondence.

In some embodiments, each of the plurality of color-resist units corresponds to multiple sub-pixels arranged continuously and of a same color.

In some embodiments, the plurality of sub-pixels include: a plurality of red sub-pixels, a plurality of green sub-pixels, and a plurality of blue sub-pixels;
the first color-resist unit is a red color-resist unit corresponding to a red sub-pixel, the second color-resist unit is a green color-resist unit corresponding to a green sub-pixel, and the third color-resist unit is a blue color-resist unit corresponding a blue sub-pixel; and
in the direction perpendicular to the base substrate, a thickness of the red color-resist unit is greater than a thickness of the blue color-resist unit, and a thickness of a green color-resist unit is greater than the thickness of the red color-resist unit.

The embodiments of the present disclosure provide a method for fabricating a display substrate, including:
providing a base substrate;
forming an inorganic color-resist layer and a plurality of sub-pixels on a side of the base substrate;
each of the plurality of sub-pixels includes a sub-pixel opening region; the inorganic color-resist layer includes a plurality of color-resist units; an orthographic projection of a color-resist unit on the base substrate covers an orthographic projection of the sub-pixel opening region on the base substrate, and the plurality of color-resist units includes: a first color-resist unit, a second color-resist unit and a third color-resist unit, at least two of the first color-resist unit, the second color-resist unit, and the third color-resist unit have different light emitting colors; the color-resist unit includes at least two inorganic sub-layers that are stacked alternately, a quantity of inorganic sub-layers included in color-resist units with different light emitting colors varies, and refractive indexes of two adjacent inorganic sub-layers are different.

In some embodiments, the forming the inorganic color-resist layer on the side of the base substrate, specifically includes:
fabricating first portions of color-resist units with different light emitting colors separately;
where a first portion included in the color-resist unit for each light emitting color is fabricated by following steps:
forming a sacrificial layer on the side of the base substrate, wherein the sacrificial layer includes a metal material;
performing a patterning process on the sacrificial layer to remove the sacrificial layer from a region corresponding to the color-resist unit of the each light emitting color;
forming a multi-layer inorganic sub-layer;
performing a patterning process on the multi-layer inorganic sub-layer to form patterns of the first portions; and
removing the sacrificial layer.

In some embodiments, the performing the patterning process on the sacrificial layer to remove the sacrificial layer from the region corresponding to the color-resist unit of the each light emitting color, specifically includes:
removing the sacrificial layer from the region corresponding to the color-resist unit of the each light emitting color by using a wet etching process.

In some embodiments, after fabricating the first portions of the color-resist units with different light emitting colors separately, further including:
forming second portions of the plurality of color-resist units on one sides of the first portions facing away from the base substrate; where the second portions of the plurality of color-resist units are integrally connected.

In some embodiments, before forming the inorganic color-resist layer, the method further includes:
forming a pattern of a first light-shielding part; where an orthographic projection of the first light-shielding part on the base substrate covers an region between orthographic projections of adjacent first portions on the base substrate, and the orthographic projection of the first light-shielding part on the base substrate and the sub-pixel opening region do not overlap each other.

The embodiments of the present disclosure provide a display apparatus, including the display substrate provided by the embodiments of the present disclosure.

### BRIEF DESCRIPTION OF FIGURES

In order to illustrate technical solutions of embodiments of the present disclosure more clearly, drawings needing to be used in descriptions of the embodiments will be introduced below briefly. Apparently, the drawings described below are only some embodiments of the present disclosure, and those ordinarily skilled in the art can further obtain other drawings according to these drawings without inventive efforts.

FIG. 1 is a schematic structural diagram of a display substrate provided by embodiments of the present disclosure.

FIG. 2 is another schematic structural diagram of a display substrate provided by embodiments of the present disclosure.

FIG. 3 is a schematic diagram of a relationship between wavelength and transmittance provided by embodiments of the present disclosure.

FIG. 4 is another schematic diagram of a relationship between wavelength and transmittance provided by embodiments of the present disclosure.

FIG. 5 is yet another schematic diagram of a relationship between wavelength and transmittance provided by embodiments of the present disclosure.

FIG. 6 is yet another schematic structural diagram of a display substrate provided by embodiments of the present disclosure.

FIG. 7 is yet another schematic structural diagram of a display substrate provided by embodiments of the present disclosure.

FIG. 8 is yet another schematic structural diagram of a display substrate provided by embodiments of the present disclosure.

FIG. 9 is yet another schematic structural diagram of a display substrate provided by embodiments of the present disclosure.

FIG. 10 is yet another schematic structural diagram of a display substrate provided by embodiments of the present disclosure.

FIG. 11 is yet another schematic structural diagram of a display substrate provided by embodiments of the present disclosure.

FIG. 12 is yet another schematic structural diagram of a display substrate provided by embodiments of the present disclosure.

FIG. 13 is yet another schematic structural diagram of a display substrate provided by embodiments of the present disclosure.

FIG. 14 is yet another schematic structural diagram of a display substrate provided by embodiments of the present disclosure.

FIG. 15 is yet another schematic structural diagram of a display substrate provided by embodiments of the present disclosure.

FIG. 16 is yet another schematic structural diagram of a display substrate provided by embodiments of the present disclosure.

FIG. 17 is yet another schematic structural diagram of a display substrate provided by embodiments of the present disclosure.

FIG. 18 is yet another schematic structural diagram of a display substrate provided by embodiments of the present disclosure.

FIG. 19 is yet another schematic structural diagram of a display substrate provided by embodiments of the present disclosure.

FIG. 20 is yet another schematic structural diagram of a display substrate provided by embodiments of the present disclosure.

FIG. 21 is yet another schematic structural diagram of a display substrate provided by embodiments of the present disclosure.

FIG. 22 is yet another schematic structural diagram of a display substrate provided by embodiments of the present disclosure.

FIG. 23 is yet another schematic structural diagram of a display substrate provided by embodiments of the present disclosure.

FIG. 24 is yet another schematic structural diagram of a display substrate provided by embodiments of the present disclosure.

FIG. 25 is a schematic flow chart of a method for fabricating a display substrate provided by embodiments of the present disclosure.

FIGS. 26 to 28 are some other schematic flow charts of a method for fabricating a display substrate provided by embodiments of the present disclosure.

FIG. 29 is a schematic structural diagram of a display apparatus provided by embodiments of the present disclosure.

Base substrate 1; sub-pixel 2; sub-pixel opening region 201; thin film transistor TFT; gate G; source S; drain D; pixel electrode 202; inorganic color-resist layer 3; color-resist unit 301; inorganic sub-layer 3011; first inorganic sub-layer 3011-1; first portion 301-1; second portion 301-2; second inorganic sub-layer 3011-2; red sub-pixel R; green sub-pixel G; blue sub-pixel B; red color-resist unit r; green color-resist unit g; blue color-resist unit b; first light-shielding part 4; inclined surface 5; superposition portion 6; first planarization layer 7; first inorganic insulation layer 8; second planarization layer 9; active layer 10; gate insulation layer 11; common electrode layer 12; buffer layer 13; second protective layer 14; first planar region 15; second light-shielding layer 16; scanning line 17; data line 18; light-emitting device 19; sacrificial layer 20; opposite substrate 21; display substrate 22; liquid crystal layer 23; black matrix 24; second opening region 25; first color-resist unit 26; second color-resist unit 27; third color-resist unit 28; first protective layer 29.

### DETAILED DESCRIPTION

In order to make the objectives, technical solutions and advantages of the embodiments of the present disclosure clearer, the technical solutions of the embodiments of the present disclosure are described clearly and completely below with reference to the drawings of the embodiments of the present disclosure. Apparently, the described embodiments are some, not all, of the embodiments of the present disclosure. The embodiments in the present disclosure and the features in the embodiments may be combined with each other without conflict. Based on the described embodiments of the present disclosure, all other embodiments obtained by those of ordinary skill in the art without inventive efforts fall within the protection scope of the present disclosure.

Unless otherwise indicated, the technical or scientific terms used in the present disclosure shall have the usual meanings understood by a person of ordinary skill in the art to which the present disclosure belongs. The words “first”, “second” and the like used in the present disclosure do not indicate any order, quantity or importance, but are only used to distinguish different components. The word “including” or “containing” and the like, means that an element or item preceding the word covers an element or item listed after the word and the equivalent thereof, without excluding other elements or items. The word “connection” or “coupling” and the like is not restricted to physical or mechanical connection, but may include electrical connection, whether direct or indirect.

It should be noted that the dimensions and shapes of the figures in the drawings do not reflect true proportions, but are intended to be illustrative of the present disclosure. And throughout the same or similar labeling denotes the same or similar elements or elements having the same or similar function.

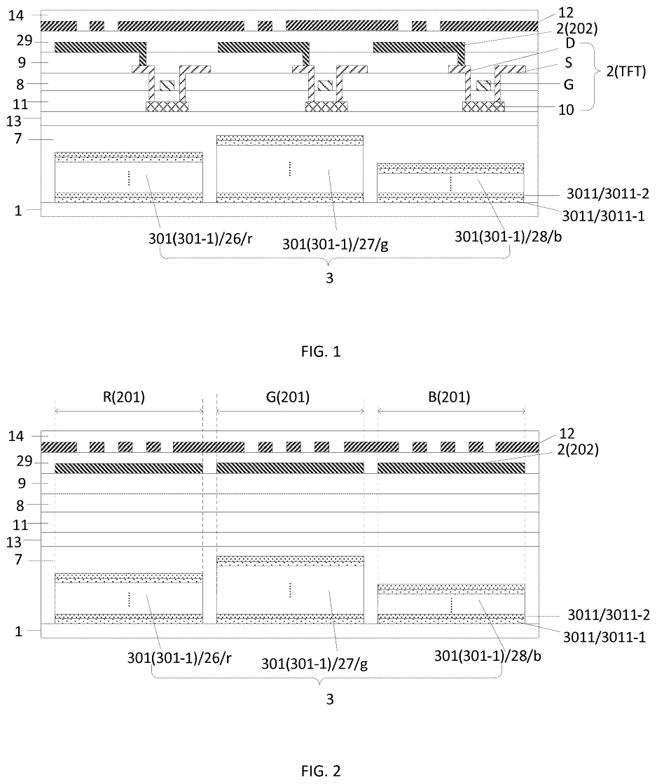

Embodiments of the present disclosure provide a display substrate, as shown in FIG. 1 and FIG. 2, the display substrate includes:
a base substrate 1;
a plurality of sub-pixels 2, located on a side of the base substrate 1; each sub-pixel 2 of the plurality of sub-pixels 2 includes a sub-pixel opening region 201;
an inorganic color-resist layer 3, located on the same side of the base substrate 1 as the plurality of sub-pixels 2 and including a plurality of color-resist units 301; herein, an orthographic projection of a color-resist unit 301 on the base substrate 1 covers an orthographic projection of the sub-pixel opening region 201 on the base substrate 1, and the plurality of color-resist units 301 include: a first color-resist unit 26, a second color-resist unit 27 and a third color-resist unit 28, at least two of the first color-resist unit 26, the second color-resist unit 27 and the third color-resist unit 28 have different light emitting colors; and the color-resist unit 301 includes at least two inorganic sub-layers 3011 that are stacked alternately, the quantity of inorganic sub-layers 3011 included in color-resist units 301 with different light emitting colors varies, and refractive indexes of two adjacent inorganic sub-layers 3011 are different.

It should be noted that, in the related art, the display product uses an absorption-type color film to emit light corresponding to the color of the sub-pixel, and the energy loss after the light passes through the colored film is large, affecting the light utilization rate of the display product. Moreover, because the conventional absorption-type color film is usually made of a resin material, and photoresist is used for exposure to realize patterning of the color film, this process is not conducive to making small-sized patterns, and thus it is difficult to improve the resolution of the display product due to limitations in the size of the color film, and it is difficult to increase the pixel density of the display product.

It should be noted that inorganic sub-layers with different refractive indexes are stacked alternately, and light interferes at the interface between the inorganic sub-layers with different refractive indexes, causing the reflectivity or the transmittance of the light within a specific wavelength range to increase. In this way, by setting the refractive index, the quantity of layers, and the thicknesses of the inorganic sub-layers, it is possible to make the alternately stacked multi-layer inorganic sub-layers transmit only the light within a specific wavelength range.

The display substrate provided in embodiments of the present disclosure includes a color-resist unit that is provided by alternately stacking at least two inorganic sub-layers, such that the color-resist unit transmits light in a wavelength range corresponding to the color of the sub-pixel. The color-resist unit formed by stacking the inorganic sub-layers does not absorb light, thereby improving the light utilization rate of the display substrate compared to the conventional absorption-type color film. Moreover, since the color-resist unit are stacked with inorganic sub-layers, which can be patterned using a dry engraving process, and compared to the resin color film of the prior art, the size of the color-resist unit can be made smaller, which can increase the pixel density of the display product, and thus the display substrate provided by the embodiments of the present disclosure can be applied to display products with ultra-high pixel density, for example, it can be applied to a Virtual Reality (VR) display product, increasing the application scenarios of the display substrate.

It should be noted that the resolution of the VR display product is usually at or above 1500 pixel density (PPI), and thus the pixel size of the VR display product is small, usually with a pixel size of <6 microns, and accordingly, the size of the color film is also small. However, there are fewer organic materials suitable for high resolution, and it is difficult to obtain high resolution color film by using photoresist for exposure process. Moreover, in order to ensure that the color gamut meets the requirements, the thickness of the color film of the organic material of the related art is usually greater than 1.5 microns, and the higher thickness of the color film is prone to the problem of color fading between different adjacent sub-pixels, and it also increases the difficulty of flattening the color film in the follow-up. In view of this, in the display substrate provided in embodiments of the present disclosure, the inorganic sub-layers that are alternately stacked are used to form an inorganic color-resist layer, and a full-color display can be achieved with a thin thickness of the inorganic color-resist layer (e.g., not greater than 1.5 microns), which is conducive to lowering the difficulty of flattening the inorganic color-resist layer, and thus reducing the difficulty in fabricating the display substrate. Moreover, since the inorganic color-resist layer can be patterned by the dry engraving process, and the precision of the dry engraving process can be less than 2 microns, even for high PPI display products with a pixel size of less than 6 microns, the resolution of the color-resist unit can also meet the requirements.

It should be noted that FIG. 1 and FIG. 2 are schematic diagrams of cross-sectional structures of different regions of the display substrate.

In specific implementations, the light emitting color of the color-resist unit is the same as the color of its corresponding sub-pixel.

In some embodiments, as shown in FIG. 1 and FIG. 2, different color-resist units 301 include a same type of inorganic sub-layer 3011.

In some embodiments, as shown in FIG. 1 and FIG. 2, at least two of the first color-resist unit 26, the second color-resist unit 27, and the third color-resist unit 28 have different thicknesses in a direction perpendicular to the base substrate 1.

In the display substrate provided in the embodiments of the present disclosure, the color-resist units with different light emitting colors have the same type of inorganic sub-layer, so that by adjusting the quantities and thicknesses of the inorganic sub-layers included in the color-resist units, it is possible to achieve different light emitting colors for different color-resist units. There is no need to prepare a variety of raw materials, which can avoid increasing the fabrication process of the display substrate.

In some embodiments, the difference in thicknesses of different color-resist units in the direction perpendicular to the base substrate is less than or equal to 1 micron.

That is, the display substrate provided in embodiments of the present disclosure has a smaller difference in thicknesses of different color-resist units in the direction perpendicular to the base substrate, which is conducive to the subsequent flattening process of the inorganic color-resist layer, and reduces the difficulty of fabricating the display substrate.

In some embodiments, as shown in FIG. 2, the plurality of sub-pixels 2 includes: a plurality of red sub-pixels R, a plurality of green sub-pixels G, and a plurality of blue sub-pixels B;
the first color-resist unit 26 is a red color-resist unit r that emits red light, the second color-resist unit 27 is a green color-resist unit g that emits green light, and the third color-resist unit 28 is a blue color-resist unit b that emits blue light; and the red color-resist unit r corresponds to the red sub-pixel R, the green color-resist unit g corresponds to the green sub-pixel G, and the blue color-resist unit b corresponds to the blue sub-pixel B; and
in the direction perpendicular to the base substrate 1, a thickness of the red color-resist unit r is greater than a thickness of the blue color-resist unit b, and a thickness of the green color-resist unit g is greater than the thickness of the red color-resist unit r.

In specific implementations, for example, the quantity of inorganic sub-layers included in the color-resist units with different light emitting colors is not exactly the same.

In specific implementations, in the direction perpendicular to the base substrate, a total thickness of a multi-layer inorganic sub-layer included in the color-resist unit is, for example, greater than or equal to 3000 angstroms and less than or equal to 30,000 angstroms. For example, a total thickness of the multi-layer inorganic sub-layer included in the red color-resist unit is greater than or equal to 5000 angstroms and less than or equal to 15,000 angstroms, a total thickness of the multi-layer inorganic sub-layer included in the blue color-resist unit is greater than or equal to 6000 angstroms and less than or equal to 20,000 angstroms, and a total thickness of the multi-layer inorganic sub-layer included in the green color-resist unit is greater than or equal to 3000 angstroms and less than or equal to 12,000 angstroms. Considering a stress demand that the color-resist unit should satisfy, the filtering effect, and the difficulty of subsequent flattening the inorganic color-resist layer, for example, the total thickness of the multi-layer inorganic sub-layer included in the color-resist unit may be greater than or equal to 5000 angstroms and less than or equal to 15,000 angstroms. The thickness of a single inorganic sub-layer is, for example, greater than or equal to 1 nanometer and less than or equal to 1000 nanometers.

In some embodiments, as shown in FIG. 1 and FIG. 2, the color-resist unit 301 includes a first inorganic sub-layer 3011-1 and a second inorganic sub-layer 3011-2; a refractive index of the first inorganic sub-layer 3011-1 is greater than a refractive index of the second inorganic sub-layer 3011-2.

It should be noted that, in FIG. 1 and FIG. 2, for example, the color-resist unit includes only a first inorganic sub-layer 3011-1 and a second inorganic sub-layer 3011-2, i.e., the color-resist unit is formed by the first inorganic sub-layer 3011-1 and the second inorganic sub-layer 3011-2 that are alternately stacked. Of course, in specific implementations, the color-resist unit may also include more inorganic sub-layers.

In some embodiments, as shown in FIGS. 1 and 2, the inorganic sub-layer 3011 closest to the base substrate 1 is the first inorganic sub-layer 3011-1.

In some embodiments, a material of the first inorganic sub-layer includes one or a combination of the following: silicon nitride (SIN), titanium dioxide (TiO₂), titanium pentoxide (Ti₂O₅), niobium pentoxide (Nb₂O₅), zirconium dioxide (ZrO₂), yttrium trioxide (Y₂O₃), and zinc sulfide (ZnS).

A material of the second inorganic sub-layer 3011 includes one or a combination of the following: silicon oxide (SiO₂), and magnesium fluoride (MgF₂).

In some embodiments, as shown in FIGS. 1-2, and FIG. 6, the color-resist unit 301 includes a first portion 301-1; and
first portions 301-1 of color-resist units 301 with different light emitting colors are provided independently of each other.

It should be noted that the first portions of the color-resist units with different light emitting colors being provided independently of each other means that the multi-layer inorganic sub-layers included in the first portions of the color-resist units with different light emitting colors are independently made. The first portions of the color-resist units with different light emitting colors may have a certain distance from each other, or may have an overlapping region.

It should be noted that if the first portions of the color-resist units with different light emitting colors do not overlap with each other, the distance between the first portions of the different color-resist units that are adjacent to each other is considered to be greater than or equal to 0. If the first portions of the color-resist units with different light emitting colors have an overlapping region between them, the distance between the first portions of the different color-resist units that are adjacent to each other is considered to be less than 0.

In some embodiments, an absolute value of the distance between the first portions of the different color-resist units that are adjacent to each other is less than or equal to 10 microns.

In specific implementations, if the first portions of the color-resist units with different light emitting colors do not overlap each other, the distance between the first portions of the different color-resist units that are adjacent to each other is greater than or equal to 0 and less than or equal to 10 microns. If the first portions of the color-resist units with different light emitting colors have an overlapping region between them, the distance between the first portions of the different color-resist units that are adjacent to each other is greater than or equal to −2 microns and less than or equal to 0.

It should be noted that the absolute value of the distance between the first portions of the different color-resist units that are adjacent to each other may be set according to the dimensions to be satisfied between adjacent sub-pixel opening regions, and the specific structure between the adjacent sub-pixel opening regions may also be considered. For a high-resolution display product such as a VR, the dimensions between the adjacent sub-pixel opening regions are smaller, and accordingly, the absolute value of the distances between the first portions of the different color-resist units that are adjacent to each other may be further reduced.

For the high-resolution display product, in some embodiments, the absolute value of the distance between the first portions of the different color-resist units that are adjacent to each other is less than or equal to 3 micrometers.

In specific implementations, if the first portions of the color-resist units with different light emitting colors do not overlap each other, the distance between the first portions of the different color-resist units that are adjacent to each other is greater than or equal to 0 and less than or equal to 3 micrometers. If the first portions of the color-resist units with different light emitting colors have an overlapping region between them, the distance between the first portions of the different color-resist units that are adjacent to each other is greater than or equal to −2 microns and less than or equal to 3.

In some embodiments, as shown in FIG. 1 and FIG. 2, the color-resist unit 301 includes only a first portion 301-1. i.e., the color-resist units 301 with different light emitting colors are provided independently of each other.

Next, thickness parameters of the inorganic sub-layers included in the color-resist units with different light emitting colors are illustrated by taking an example of the color-resist unit including only the first portion.

As shown in Table I, the red color-resist unit, the green color-resist unit, and the blue color-resist unit are formed by a first inorganic sub-layer and a second inorganic sub-layer that are alternately stacked, the material of the first inorganic sub-layer is TiO₂, and the material of the second inorganic sub-layer is SiO₂. The smaller the number corresponding to the number of layers in Table I, the closer the layer of the inorganic sub-layer is to the base substrate, i.e., TiO₂ with the number 1 of layers is the inorganic sub-layer closest to the base substrate. Both the red color-resist unit and the green color-resist unit include 16 inorganic sub-layers, and the blue color-resist unit includes 9 inorganic sub-layers. The red color-resist unit has a total thickness of 980 nm, the green color-resist unit has a total thickness of 1081 nm, and the blue color-resist unit has a total thickness of 670 nm.

TABLE I

| Number of | Blue color-resist unit | | Green color-resist unit | | Red color-resist unit | |
|---|---|---|---|---|---|---|
| layers | Material | Thickness/nm | Material | Thickness/nm | Material | Thickness/nm |
| 1 | TiO₂ | 50 | TiO₂ | 70 | TiO₂ | 50 |
| 2 | SiO₂ | 120 | SiO₂ | 80 | SiO₂ | 50 |
| 3 | TiO₂ | 50 | TiO₂ | 95 | TiO₂ | 50 |
| 4 | SiO₂ | 90 | SiO₂ | 70 | SiO₂ | 50 |
| 5 | TiO₂ | 60 | TiO₂ | 50 | TiO₂ | 50 |
| 6 | SiO₂ | 100 | SiO₂ | 66 | SiO₂ | 80 |
| 7 | TiO₂ | 50 | TiO₂ | 95 | TiO₂ | 50 |
| 8 | SiO₂ | 90 | SiO₂ | 80 | SiO₂ | 50 |
| 9 | TiO₂ | 60 | TiO₂ | 50 | TiO₂ | 50 |
| 10 | | | SiO₂ | 80 | SiO₂ | 80 |
| 11 | | | TiO₂ | 95 | TiO₂ | 50 |
| 12 | | | SiO₂ | 50 | SiO₂ | 60 |
| 13 | | | TiO₂ | 70 | TiO₂ | 50 |
| 14 | | | SiO₂ | 50 | SiO₂ | 50 |
| 15 | | | TiO₂ | 90 | TiO₂ | 50 |
| 16 | | | SiO₂ | 50 | SiO₂ | 160 |

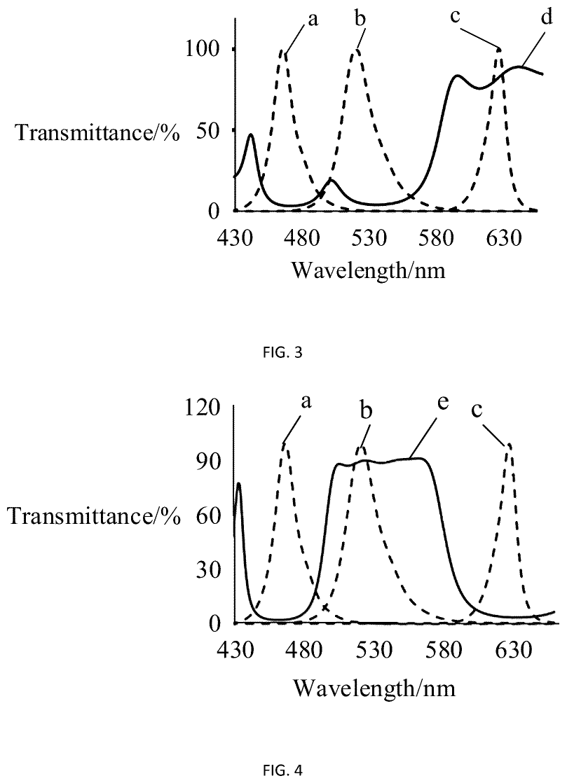

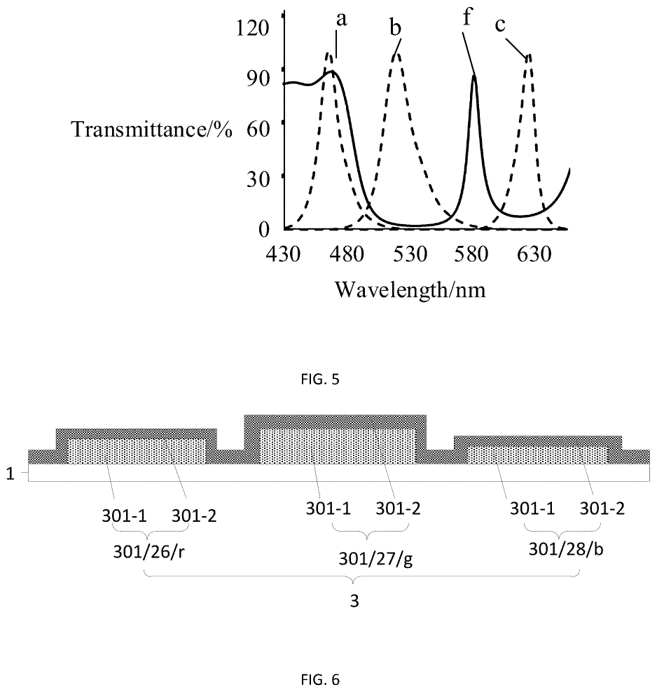

As shown in Table II, the red color-resist unit, the green color-resist unit, and the blue color-resist unit are formed by a first inorganic sub-layer and a second inorganic sub-layer that are alternately stacked, the material of the first inorganic sub-layer is SiN, and the material of the second inorganic sub-layer is SiO₂. The smaller the number corresponding to the number of layers in Table II, the closer the inorganic sub-layer is to the base substrate, i.e., SiN with the number of layer 1 is the inorganic sub-layer closest to the substrate. The red color-resist unit includes 22 inorganic sub-layers, the green color-resist unit includes 23 inorganic sub-layers, and the blue color-resist unit includes 19 inorganic sub-layers. The red color-resist unit has a total thickness of 1846 nm, the green color-resist unit has a total thickness of 2020 nm, and the blue color-resist unit has a total thickness of 1713 nm. The curves of the relationships between wavelength and transmittance corresponding to the color-resist unit are shown in FIGS. 3-5, respectively; FIGS. 3-5 further show the relationship between the wavelength and transmittance of the light emitted from a monochrome light-emitting device, and the curves a, b, and c are the relationship between the wavelength and transmittance of the light emitted from the blue light-emitting device, the relationship between the wavelength and transmittance of the light emitted from the green light-emitting device, and the relationship between the wavelength and transmittance of the light emitted from the red light-emitting device, respectively. The curve d in FIG. 3 denotes the relationship between the wavelength and transmittance of the red color-resist unit in Table II, the curve e in FIG. 4 denotes the relationship between the wavelength and transmittance of the green color-resist unit in Table II, and the curve f in FIG. 5 denotes the relationship between the wavelength and transmittance of the blue color-resist unit in Table II. From FIG. 3 to FIG. 5, it can be seen that the red color-resist unit has a higher transmittance rate for red light and a lower transmittance rate for blue light and green light, the green color-resist unit has a higher transmittance rate for green light and a lower transmittance rate for blue light and red light, and the blue color-resist unit has a higher transmittance rate for blue light and a lower transmittance rate for red light and green light. In other words, by alternately stacking inorganic sub-layers with different refractive indexes, and by designing the number and thickness of the inorganic sub-layers, it is possible to make the structure formed by alternately stacking the multiple inorganic sub-layers have the function of a color film, so as to obtain that the emitting light of the color-resist unit formed by alternately stacking the multiple inorganic sub-layers corresponds to the color of the sub-pixel.

TABLE II

| Number of | Blue color-resist unit | | Green color-resist unit | | Red color-resist unit | |
|---|---|---|---|---|---|---|
| layers | Material | Thickness/nm | Material | Thickness/nm | Material | Thickness/nm |
| 1 | SiN | 90 | SiN | 60 | SiN | 65 |
| 2 | SiO₂ | 106 | SiO₂ | 100 | SiO₂ | 88 |
| 3 | SiN | 75 | SiN | 40 | SiN | 65 |
| 4 | SiO₂ | 100 | SiO₂ | 30 | SiO₂ | 88 |
| 5 | SiN | 70 | SiN | 70 | SiN | 65 |
| 6 | SiO₂ | 95 | SiO₂ | 90 | SiO₂ | 88 |
| 7 | SiN | 70 | SiN | 70 | SiN | 65 |
| 8 | SiO₂ | 95 | SiO₂ | 90 | SiO₂ | 88 |
| 9 | SiN | 70 | SiN | 70 | SiN | 65 |
| 10 | SiO₂ | 90 | SiO₂ | 185 | SiO₂ | 88 |
| 11 | SiN | 177 | SiN | 65 | SiN | 65 |
| 12 | SiO₂ | 95 | SiO₂ | 95 | SiO₂ | 88 |
| 13 | SiN | 70 | SiN | 65 | SiN | 65 |
| 14 | SiO₂ | 95 | SiO₂ | 95 | SiO₂ | 88 |
| 15 | SiN | 70 | SiN | 70 | SiN | 270 |
| 16 | SiO₂ | 95 | SiO₂ | 185 | SiO₂ | 80 |
| 17 | SiN | 70 | SiN | 65 | SiN | 60 |
| 18 | SiO₂ | 100 | SiO₂ | 95 | SiO₂ | 75 |
| 19 | SiN | 80 | SiN | 65 | SiN | 60 |
| 20 | | | SiO₂ | 100 | SiO₂ | 80 |
| 21 | | | SiN | 70 | SiN | 60 |
| 22 | | | SiO₂ | 180 | SiO₂ | 90 |
| 23 | | | SiN | 65 | | |

In specific implementations, for example, as shown in Tables I and II, the thicknesses of the inorganic sub-layers with the same number of layers in the color-resist units having different light emitting colors are completely different or not completely the same. Of course, in specific implementation, it is also possible to set the thickness of at least some of the inorganic sub-layers with the same layer number in the color-resist units with different light emitting colors to be the same, so that these inorganic sub-layers can be used as a common layer of the color-resist layer without the need for patterning.

In some embodiments, as shown in FIG. 6, the color-resist unit 301 further includes a second portion 301-2 located at a side of the first portion 301-1 facing away from the base substrate 1; and the second portions 301-2 of the plurality of color-resist units 301 are integrally connected.

It should be noted that since the color-resist unit is made of the inorganic material, the inorganic material needs to be patterned to form a pattern of the color-resist unit through a patterning process after the inorganic material is formed into a film, and the patterning process of the inorganic film usually includes an etching process. Since the thickness of the color-resist unit is thicker, for example, the thickness of the green color-resist unit is greater than 1000 nanometers in the scheme corresponding to Table I, and the thickness of the green color-resist unit is greater than 2000 nanometers in the scheme corresponding to Table II, it is more difficult to etch when the thickness of the film layer is thicker.

In the display substrate provided by embodiments of the present disclosure, the second portions of the color-resist units with different light emitting colors are integrally connected, i.e., only the pattern of the first portion needs to be formed by a patterning process, which reduces the thickness of the film layer that needs to be etched, and simplifies the difficulty of the fabrication of the color-resist unit.

In specific implementations, the first portion and the second portion both include a first inorganic sub-layer and a second inorganic sub-layer arranged stacked alternately. For example, the quantities of inorganic sub-layers included in the first portions of the color resist-units with different light emitting colors are not exactly the same. The quantities and thicknesses of the inorganic sub-layers included in the second portions of the color-resist units with different light emitting colors are the same.

In some embodiments, as shown in FIG. 6, the first portions 301-1 of at least two of the first color-resist unit 26, the second color-resist unit 27, and the third color-resist unit 28 have different thicknesses in the direction perpendicular to the base substrate 1.

In some embodiments, as shown in FIG. 6, the first portions 301-1 of the first color-resist unit 26, the second color-resist unit 27, and the third color-resist unit 28 have different thicknesses in the direction perpendicular to the base substrate 1.

In some embodiments, as shown in FIG. 6, in the direction perpendicular to the base substrate 1, the thickness of the first portion 301-1 of the red color-resist unit r is greater than the thickness of the first portion 301-1 of the blue color-resist unit b, and the thickness of the first portion 301-1 of the green color-resist unit g is greater than the thickness of the first portion 301-1 of the red color-resist unit r. In this way, it is still possible to achieve that the thickness of the red color-resist unit r is greater than the thickness of the blue color-resist unit b, and the thickness of the green color-resist unit g is greater than the thickness of the red color-resist unit r, in the direction perpendicular to the base substrate 1.

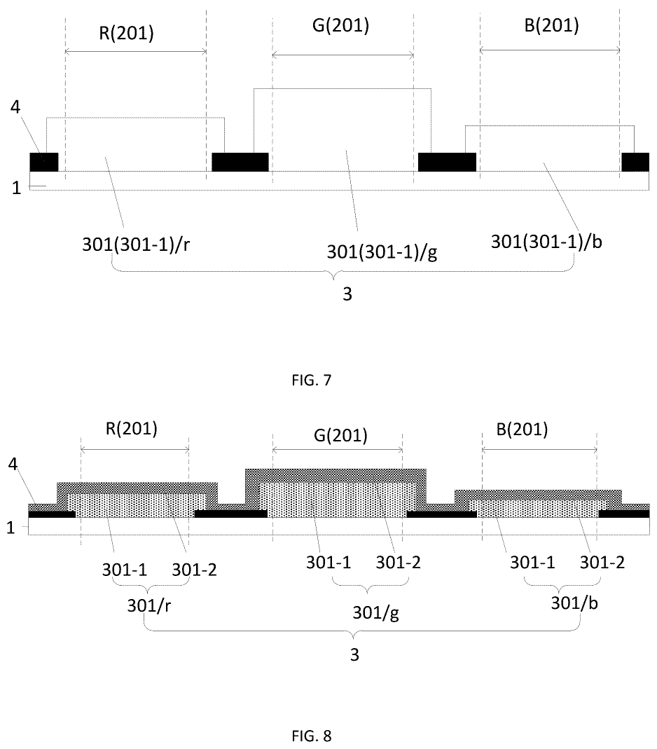

In some embodiments, as shown in FIGS. 7-8, the display substrate further includes:
a first light-shielding part 4, located between the first portion 301-1 and the base substrate 1. An orthographic projection of the first light-shielding part 4 on the base substrate 1 covers an region between orthographic projections of adjacent first portions 301-1 on the base substrate 1, and the orthographic projection of the first light-shielding part 4 on the base substrate 1 does not overlap the sub-pixel opening region 201.

The display substrate provided in the embodiments of the present disclosure is provided with the first light-shielding part between the adjacent first portions and between the sub-pixel opening regions, so that light leakage from the region between adjacent sub-pixel opening regions can be avoided, and the brightness of light emitted from the sub-pixel opening regions can be enhanced, and thus the contrast of the display substrate can be enhanced. Moreover, the orthographic projection of the first light-shielding part on the base substrate and the sub-pixel opening regions do not overlap with each other, which also prevents the first light-shielding part from blocking the sub-pixel opening regions and avoiding affecting the opening rate of the sub-pixel.

It should be noted that FIG. 7 illustrates by taking the color-resist unit 301 including only a first portion 301-1 as an example. FIG. 8 illustrates by taking the color-resist unit 301 including a first portion 301-1 and a second portion 301-2 as an example. The second portion 301-2 covers the first light-shielding part 4 in a region between the sub-pixel opening regions 201 and in a region between adjacent first portions 301-1.

It should be noted that FIGS. 1-2, and FIG. 6-8 illustrate by taking an example that a lateral surface of the first portion 301-1 is perpendicular to the base substrate 1. However, in the actual fabrication process of the inorganic color-resist layer, when the first portion is formed by an etching process, due to process limitations, it may occur that an included angle between the lateral surface of the pattern of the first portion and the base substrate is less than 90°.

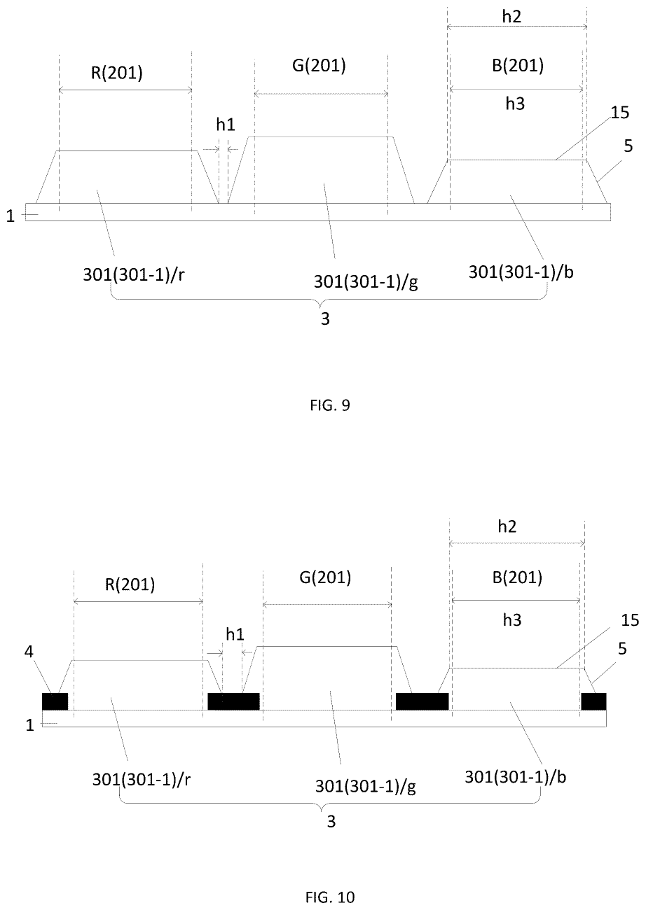

In some embodiments, as shown in FIGS. 9-14, the lateral surface of the first portion 301-1 include an inclined surface 5, and an included angle between the inclined surface 5 and a plane where the base substrate 1 is located is less than 90°.

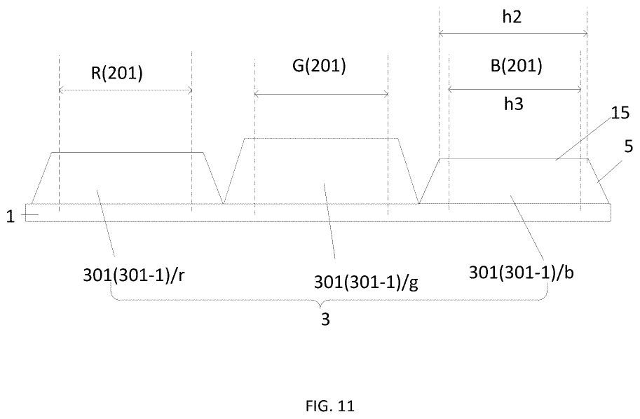

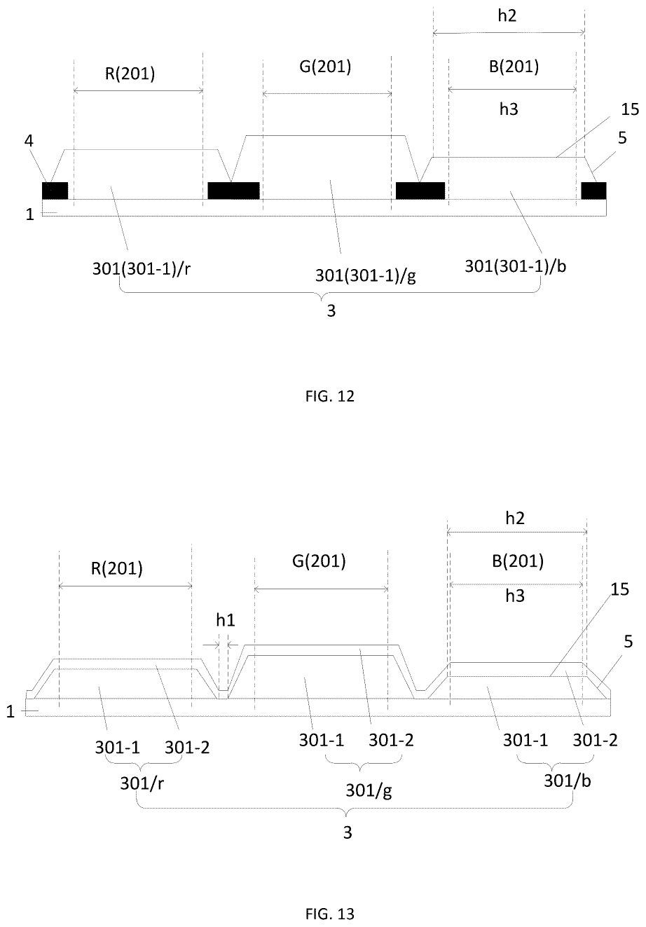

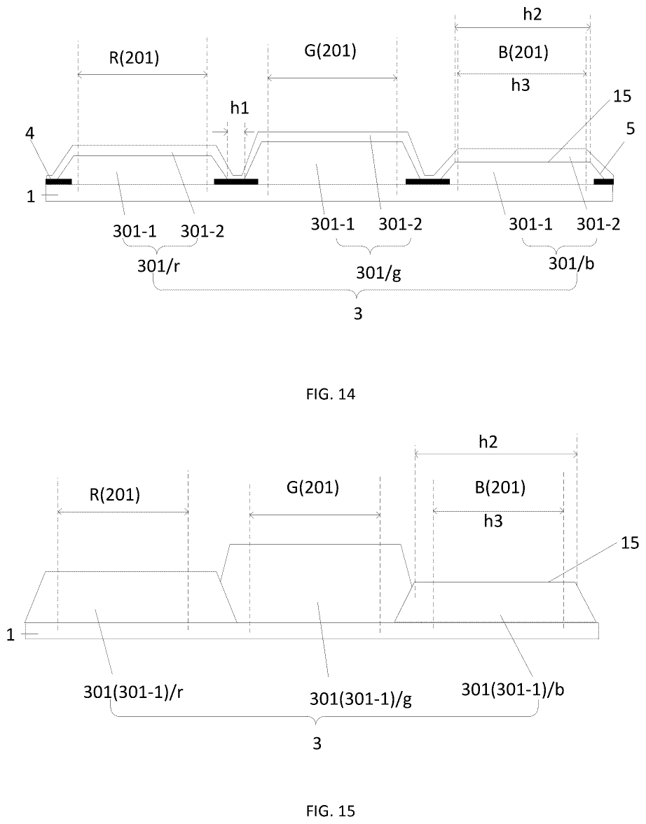

It should be noted that FIG. 9, FIG. 11, and FIG. 13 are illustrated with the region between the first portions 301-1 not provided with the first light-shielding part as an example, a cross-section of the first portions 301-1 in the direction perpendicular to the base substrate 1 is a trapezoid, and a length of the upper bottom edge of the trapezoid is less than a length of the lower bottom edge of the trapezoid. FIG. 10, FIG. 12, and FIG. 14 illustrate by taking the region between the first portions 301-1 being provided with the first light-shielding part 4 as an example, a cross-section of a portion of the first portion 301-1 above the first light-shielding part 4 is trapezoid in the direction perpendicular to the base substrate 1, and a length of the upper bottom edge of the trapezoid is less than a length of the lower bottom edge of the trapezoid.

In specific implementations, the included angle between the inclined surface and the base substrate is greater than or equal to 60° and less than 90°.

In some embodiments, an absolute value of the minimum distance between inclined surfaces of two adjacent first portions is less than or equal to 5 microns.

In some embodiments, the inclined surfaces of the two adjacent first portions do not overlap each other, as shown in FIGS. 9-10, and the minimum distance h1 between the inclined surfaces 5 of the two adjacent first portions 301-1 is greater than or equal to 0 and less than or equal to 5 microns.

It should be noted that the minimum distance between the inclined surfaces of the two first portions is the distance between the bottommost ends of the inclined surfaces of the two first portions. FIGS. 9-10 illustrate by taking h1 being greater than 0 as an example. In specific implementations, it is also possible that the minimum distance between the inclined surfaces 5 of the two adjacent first portions 301-1 is equal to 0, as shown in FIGS. 11-12.

It should be noted that when the color-resist unit includes the first portion and the second portion, the display substrate provided by embodiments of the present disclosure shown in FIGS. 13 and 14 is illustrated by an example of h1 being greater than 0. Of course, in specific implementations, when the color-resist unit includes the first portion and the second portion, it is also possible to set h1 to be equal to 0.

Of course, in some embodiments, it may also be the case that orthographic projections of adjacent first portions 301-1 on the base substrate 1 have an overlap in the region between adjacent sub-pixel opening regions 201 as shown in FIG. 15; and an orthographic projection of a first portion 301-1 on the base substrate 1 and an orthographic projection, on the base substrate 1, of a sub-pixel opening region 201 corresponding to its adjacent first portion 301-1 do not overlap each other.

That is, adjacent color-resist units may have an overlap in the region between the sub-pixel opening regions.

It should be noted that adjacent first portions have an overlap only in the region between the sub-pixel opening regions, and do not overlap each other in the sub-pixel opening regions, and thus do not affect the light emitting color of the sub-pixel opening regions.

In specific implementations, in the regions between the sub-pixel opening regions, the light transmittance may be reduced in the portions of the adjacent color-resist units having the overlapping regions by setting, so as to avoid crosstalk of the light between the sub-pixels.

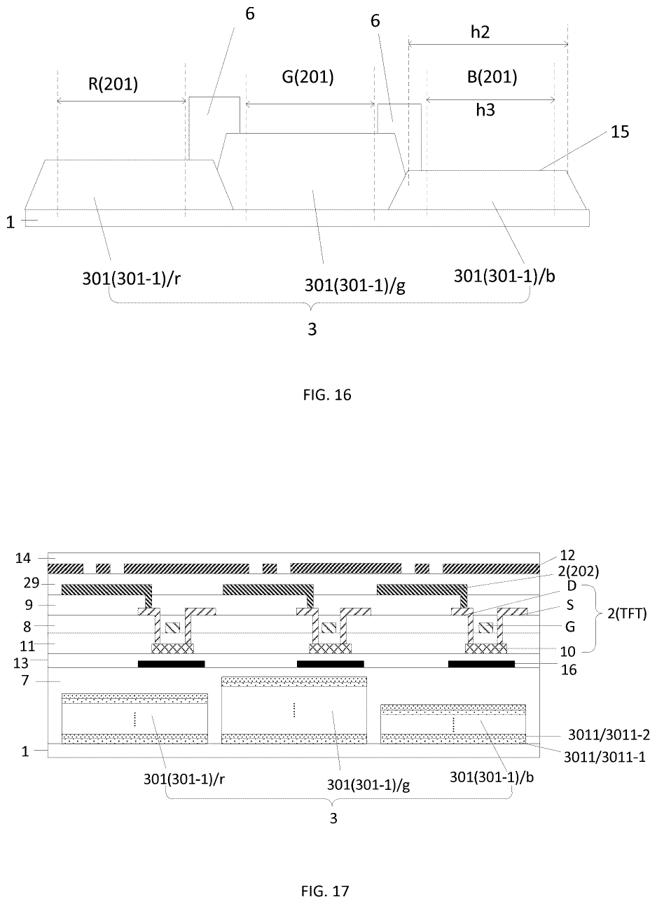

In some embodiments, as shown in FIG. 16, an orthographic projection of any first portion 301-1 on the base substrate 1 covers an orthographic projection of a region between adjacent sub-pixel opening regions 201 on the base substrate 1.

The inorganic color-resist layer 3 further includes: a plurality of superposition portions 6; orthographic projections of the superposition portions 6 on the base substrate 1 cover orthographic projections of regions between adjacent sub-pixel opening regions 201 on the base substrate 1, and the orthographic projections of the superposition portions 6 on the base substrate 1 do not overlap the orthographic projections of the sub-pixel opening regions 201 on the base substrate 1.

In some embodiments, between adjacent sub-pixel opening regions, the orthographic projections of the adjacent color-resist units and the orthographic projection of the superposition portion on the base substrate have an overlapping region having a light transmittance of less than 5%. That is, the visible light cannot pass through the overlapping region between the orthographic projections of the color-resist units and the orthographic projection of the superposition portion on the base substrate, so that the combination of the color-resist units and the superposition portion in this overlapping region has a shading effect, so that the light crosstalk between the sub-pixels can be avoided.

In some embodiments, the superposition portion is also formed by inorganic sub-layers with different refractive indexes that are alternately stacked together. When the color-resist unit includes a first inorganic sub-layer and a second inorganic sub-layer, the superposition portion may also include the first inorganic sub-layer and the second inorganic sub-layer.

In some embodiments, the quantity of inorganic sub-layers and the thicknesses of inorganic sub-layers included in multiple superposition portions are not exactly the same.

In some embodiments, as shown in FIG. 16, the superposition portion 6 is located at a side of the inorganic color-resist layer 3 facing away from the base substrate 1.

In specific implementations, the superposition portion may be formed after the inorganic color-resist layer is fabricated.

Alternatively, in some embodiments, the superposition portion is located between the inorganic color-resist layer and the base substrate, i.e., the superposition portion is formed first, and the inorganic color-resist layer is formed afterwards. When the display substrate includes a first light-shielding layer, the superposition portion is located between the first light-shielding layer and the inorganic color-resist layer.

Alternatively, in some embodiments, the superposition portion may be provided on the same layer as a first portion of a certain type of color-resist unit. The superposition portion corresponding to a red color-resist unit and a green color-resist unit adjacent each other is a first superposition portion, the superposition portion corresponding to a red color-resist unit and a blue color-resist unit adjacent to each other is a second superposition portion, and the superposition portion corresponding to a green color-resist unit and a blue color-resist unit adjacent to each other is a third superposition portion. That is, the first superposition portion is provided on the same layer as a first portion of the blue color-resist unit, the second superposition portion is provided on the same layer as a first portion of the green color-resist unit, and the third superposition portion is provided on the same layer as a first portion of the red color-resist unit. The positions of the first superposition portion, the second superposition portion, and the third superposition portion are related to the fabrication sequence of the red color-resist unit, the blue color-resist unit, and the green color-resist unit. If the red color-resist unit, the blue color-resist unit, and the green color-resist unit are fabricated sequentially, in the direction perpendicular to the base substrate, the first superposition portion is located between the first portion of the red color-resist unit and the first portion of the green color-resist unit, and the second superposition portion is located at one sides of the first portion of the red color-resist unit and the first portion of the blue color-resist unit facing away from the base substrate, and the third superposition portion is located between the base substrate and the first portion of the green color-resist unit and the first portion of the blue color-resist unit.

In some embodiments, as shown in FIGS. 9-16, a surface of the first portion 301-1 away from the base substrate 1 includes a first planar region 15; an orthographic projection of the first planar region 15 on the base substrate 1 covers the sub-pixel opening region 201. That is, a width h2 of the first planar region 15 is greater than or equal to a width h3 of the sub-pixel opening region 201.

The display substrate provided by embodiments of the present disclosure, the orthographic projection of the first planar region on the base substrate covers the sub-pixel opening region, i.e., in a region corresponding to the sub-pixel opening region, the first portion includes a complete multi-layer inorganic sub-layer, and an inclined surface of the first portion is located only between the sub-pixel opening regions, so that it can be ensured that the color-resist unit includes the complete multi-layer inorganic sub-layer, which can avoid the influence on the light transmittance due to the change of the thickness of the inorganic sub-layer in the region corresponding to the inclined surface.

In some embodiments, as shown in FIG. 1, the sub-pixel 2 includes: a thin film transistor TFT, and a pixel electrode 202 located at the side of the thin film transistor TFT facing away from the base substrate 1.

That is, the display substrate provided by embodiments of the present disclosure can be used as an array substrate for a liquid crystal display panel.

In some embodiments, as shown in FIG. 1, the thin film transistor TFT includes: a gate G, a source S, and a drain D; and the display substrate further includes: a first inorganic insulation layer 8 between the gate G, and the source S and the drain D, and a second planarization layer 9 between the source S and the drain D, and the pixel electrode 202.

In some embodiments, as shown in FIG. 1, the thin-film transistor TFT further includes: an active layer 10. The thin-film transistor TFT in FIG. 1 is a top-gate structure, i.e., the gate G is located at the side of the active layer 10 facing away from the base substrate 1. Of course, in specific implementations, the thin film transistor may also be a bottom-gate structure, i.e., the gate is located between the active layer and the base substrate.

In some embodiments, as shown in FIG. 1, the display substrate further includes: a gate insulation layer 11 between the gate G and the active layer 10.

In specific implementations, the thin-film transistors are, for example, not overlapped with the sub-pixel opening regions, i.e., the thin-film transistors are located in regions outside the sub-pixel opening regions, for example, the thin-film transistors are located in regions between adjacent sub-pixel opening regions, so that the influence on the light transmittance of the sub-pixel opening regions can be avoided. In specific implementations, the orthographic projection of the color-resist unit on the base substrate may cover an orthographic projection of the thin film transistor on the base substrate.

In some embodiments, as shown in FIG. 1, the display substrate further includes:

a buffer layer 13 between the base substrate 1 and the thin film transistor TFT.

In some embodiments, as shown in FIG. 1, the display substrate further includes: a first protective layer 29 located at a side of the pixel electrode 202 facing away from the base substrate 1; a common electrode layer 12 located at a side of the first protective layer 29 facing away from the base substrate 1, and a second protective layer 14 located at a side of the common electrode layer 12 facing away from the base substrate 1.

In some embodiments, as shown in FIG. 1, the inorganic color-resist layer 3 is located between the base substrate 1 and the sub-pixels 2.

The display substrate further includes: a first planarization layer 7 located between the inorganic color-resist layer 3 and the sub-pixels 2.

In specific implementations, a high temperature process exists in a process for manufacturing the thin film transistor, and in order to avoid the high temperature process from affecting the inorganic color-resist layer, the first planarization layer may be selected to be made of a material that is resistant to high temperature. For example, the first planarization layer has a temperature resistance greater than 300 degrees Celsius (° C.).

In some embodiments, the material of the first planarization layer includes organic silicone (SOG). The SOG material is resistant to high temperature and has good flattening effect, which is conducive to improving the yield of the display substrate.

In some embodiments, the first planarization layer has a thickness greater than or equal to 0.5 microns and less than or equal to 2 microns in the direction perpendicular to the base substrate.

In some embodiments, as shown in FIG. 17, the display substrate further includes a second light-shielding layer 16 located between the buffer layer 13 and the thin film transistor TFT, and an orthographic projection of the active layer 10 on the base substrate 1 falls within an orthographic projection of the second light-shielding layer 16 on the base substrate 1.

Therefore, the second light-shielding layer can block the active layer of the thin film transistor, to avoid light incident into the channel region of the thin film transistor, and avoiding affecting the operational stability of the thin film transistor.

In specific implementations, the second light-shielding layer and the sub-pixel opening region do not overlap each other, i.e., the second light-shielding layer is also located in a region outside the sub-pixel opening region, for example, the second light-shielding layer is located in a region between the adjacent sub-pixel opening regions, so as to avoid affecting the light transmittance of the sub-pixel opening region. In specific implementations, the orthographic projection of the color-resist unit on the base substrate may cover an orthographic projection of the second light-shielding layer on the base substrate.

In some embodiments, as shown in FIG. 1, the buffer layer 13 is located between the first planarization layer 7 and the thin film transistor TFT when the inorganic color-resist layer 3 is located between the base substrate 1 and the sub-pixel 2.

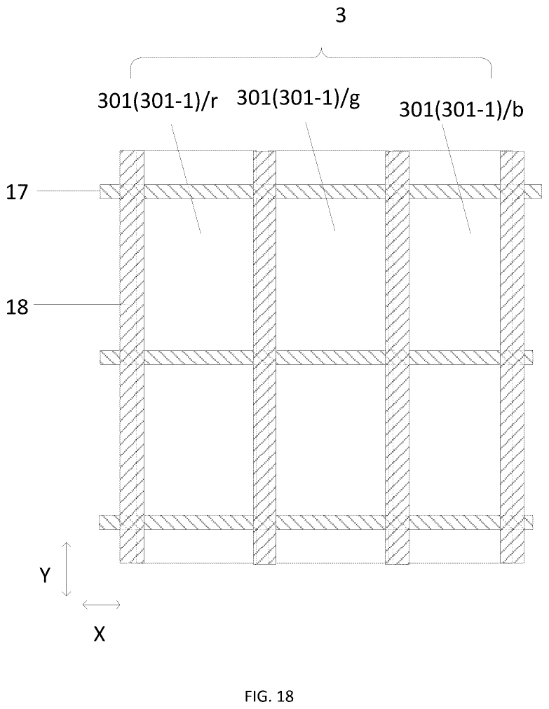

In some embodiments, as shown in FIG. 18, the display substrate further includes a plurality of scanning lines 17 and a plurality of data lines 18; the scanning lines 17 and the data lines 18 are intersected with each other to divide regions of the sub-pixels; the scanning lines 17 extend in a first direction X, and the data lines 18 extend in a second direction Y.

In specific implementations, the scanning lines are electrically connected with the gate, and the data lines are electrically connected with the source.

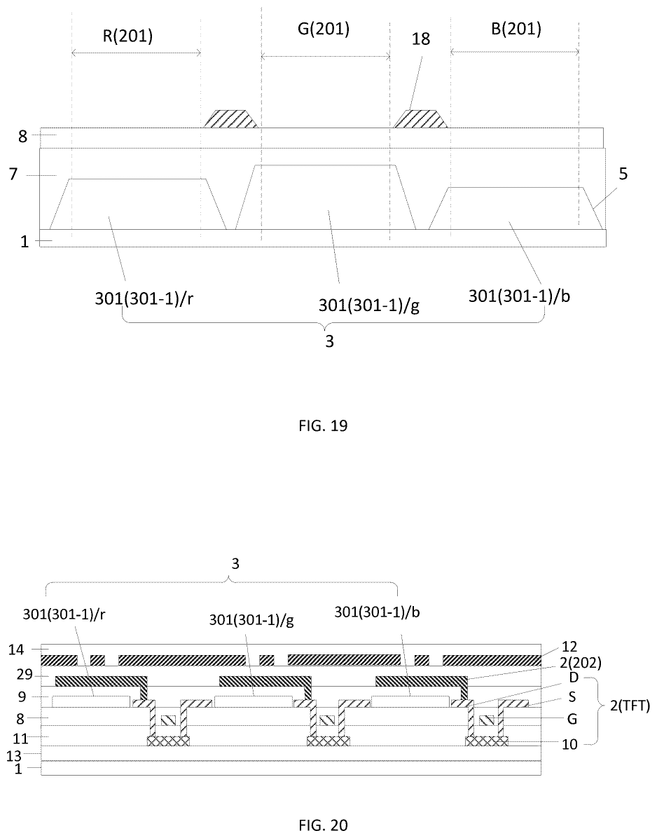

In specific implementations, orthographic projections of the scanning lines and orthographic projections of the data lines on the base substrate are not overlapped with the sub-pixel opening regions. When the color-resist unit has an overlap with a region between adjacent sub-pixel opening regions in the first direction X, the orthographic projection of the color-resist unit on the base substrate may have an overlap with the orthographic projections of the data lines on the base substrate, and the orthographic projection of the color-resist unit on the base substrate may have an overlap with the orthographic projections of the scanning lines on the base substrate. Taking the data line as an example, for example, as shown in FIG. 19, the orthographic projections of the data line 18 on the base substrate 1 covers the orthographic projection of the inclined surface 5 of the first portion 301-1 on the base substrate 1. In specific implementations, as shown in FIG. 19, the side surfaces of the data lines 18 are also inclined surfaces. The data line 18 is provided, for example, on the same layer as the source and the drain (not shown), i.e., the data line 18 is located at a side of the first inorganic insulation layer 8 facing away from the base substrate 1.

It should be noted that the film layer between the first planarization layer 7 and the first inorganic insulation layer 8 is omitted in FIG. 19.

In specific implementations, the orthographic projection of the data line on the base substrate covers the orthographic projection of the inclined surface of the first portion on the base substrate, so that the absolute value of the distance at any position between the inclined surfaces of the adjacent first portions does not exceed the line width of the data line. For a display product with high resolution, the line width of the data line is smaller. For example, for the display product with a resolution of 1200 PPI, the line width of the data line is greater than or equal to 1.2 microns and less than or equal to 2 microns; for example, when the line width of the data line is equal to 1.2 microns, the absolute value of the distance at any position between the inclined surfaces of the adjacent first portions does not exceed 1.2 microns. For a display product with a resolution of 1500 PPI, the line width of the data line is greater than or equal to 1 micron and less than or equal to 1.8 microns; for example, when the line width of the data line is equal to 1 micron, the absolute value of the distance at any position between the inclined surfaces of the adjacent first portions does not exceed 1 micron. For a display product with a resolution greater than 2000 PPI, the line width of the data line is greater than or equal to 1 micron and less than or equal to 1.5 microns; for example, when the line width of the data line is equal to 1.5 microns, the absolute value of the distance at any position between the inclined surfaces of the adjacent first portions does not exceed 1.5 microns.

In specific implementations, for two color-resist units adjacent to each other in the second direction, the orthographic projection of the scanning line on the base substrate covers the orthographic projection of the inclined surface of the first portion on the base substrate. The sides of the scanning line may also be beveled.

In specific implementations, the scanning lines are provided on the same layer as the gate. When the first portions of the plurality of color-resist units are disconnected from each other in the second direction, the orthographic projection of the scanning line on the base substrate covers the orthographic projection of the inclined surface of the first portion on the base substrate.

Alternatively, in some embodiments, as shown in FIG. 20, the inorganic color-resist layer 3 is located between the thin film transistor TFT and the pixel electrode 202.

In some embodiments, as shown in FIG. 20, the inorganic color-resist layer 3 is located between the first inorganic insulation layer 8 and the second planarization layer 9. That is, the inorganic color-resist layer is fabricated on a side of the first inorganic insulation layer facing away from the base substrate.

It should be noted that an insulation layer, such as a second planarization layer, located at a side of the first inorganic insulation layer facing away from the base substrate is usually an organic insulation layer, compared to an organic film layer, the inorganic film layer is not easy to be damaged in an etching process, especially in a dry etching process, and the fabrication of an inorganic color-resist layer on the first inorganic insulation layer can be avoided to influence the yield of the fabrication of the display substrate.

In specific implementations, the inorganic color-resist layer can be fabricated on the first inorganic insulation layer after forming the source and drain. The inorganic color-resist layer may cover a portion of the source and drain, but the inorganic color-resist layer cannot cover the region where the pixel electrode is electrically connected with the drain.

It should be noted that since the second planarization layer covers an inorganic color-resist layer, the second planarization layer includes a material that is resistant to high temperatures. For example, the second planarization layer includes a material that is temperature resistant to greater than 200° C.

In some embodiments, the material of the second planarization layer includes a resin. The resin material is resistant to high temperature and has a light transmittance of greater than 90%, which ensures the flattening effect while avoiding damage to the inorganic color-resist layer, and is also conducive to improving the light utilization rate of the display substrate.

In some embodiments, the thickness of the second planarization layer in the direction perpendicular to the base substrate is greater than or equal to 0.5 microns and less than or equal to 2 microns.

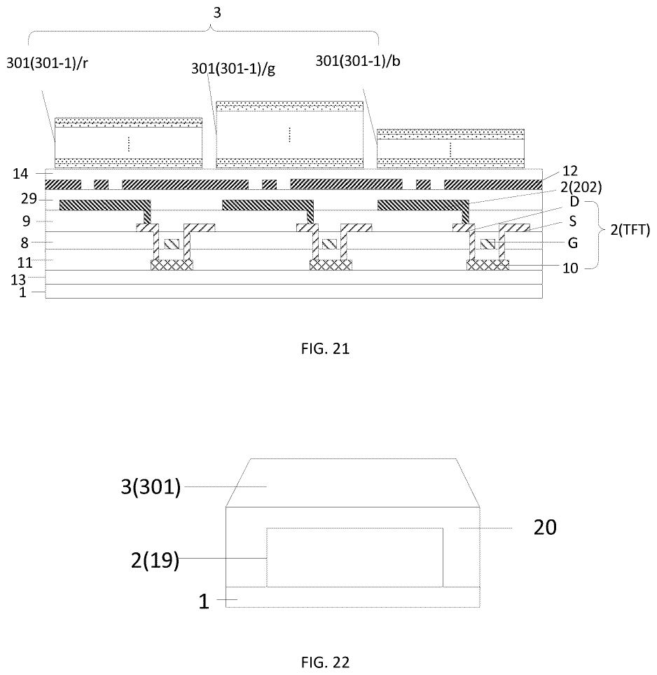

Of course, in some embodiments, the inorganic color-resist layer 3 may also be set up as shown in FIG. 21 according to practical needs, with the inorganic color-resist layer 3 being located at the side of the sub-pixel 2 facing away from the base substrate 1.

In specific implementations, when the display substrate further includes a common electrode, for example, as shown in FIG. 21, the inorganic color-resist layer 3 is located at a side of the second protective layer 14 facing away from the base substrate 1. In specific implementations, the display substrate may also include a third protective layer located at a side of the inorganic color-resist layer facing away from the base substrate.

In specific implementations, the display substrate may also be applied to an electroluminescent display product.

In some embodiments, as shown in FIG. 22, the sub-pixel 2 includes a light-emitting device 19; the inorganic color-resist layer 3 is located at a side of the light-emitting device 19 facing away from the base substrate 1.

In specific implementations, for example, the light-emitting device may be an electroluminescent device. The electroluminescent device is, for example, at least one of an organic light-emitting diode device, a quantum dot light-emitting diode device, and a micro-sized inorganic light-emitting diode device. The micro-sized inorganic light-emitting diode device may, for example, be a micro inorganic light-emitting diode device or a mini inorganic light-emitting diode device.

In specific implementations, when the light-emitting device is an organic light-emitting diode device or a quantum dot light-emitting diode device, the display substrate further includes: a pixel driving circuit located between the base substrate and the light-emitting device. The pixel driving circuit includes a plurality of thin-film transistors and may also include a capacitor. The display substrate further includes a pixel definition layer, the pixel definition layer includes first opening regions that correspond one-to-one with the sub-pixel opening regions, and the light-emitting device includes an anode, a light-emitting function layer, and a cathode arranged stacked in the first opening region. In specific implementations, a pattern of the anode is made first, and then the pixel definition layer is made, the pixel definition layer covers the edges of the anode, and an orthographic projection of the first opening region on the base substrate falls within an orthographic projection of the anode on the base substrate. The anode is electrically connected with a drain of at least one thin film transistor. The cathodes of different light-emitting devices may be integrally connected.

In some embodiments, as shown in FIG. 22, the display substrate further includes an encapsulation layer located between the light-emitting device 19 and the inorganic color-resist layer 3.

In specific implementations, when the light-emitting device is an organic light-emitting diode device or a quantum dot light-emitting diode device, the encapsulation layer includes, for example, an inorganic encapsulation layer, an organic encapsulation layer, and an inorganic encapsulation layer arranged stacked.

In specific implementations, when the display substrate includes the light-emitting device, the display substrate can be used as a backlight source of the backlight module of the liquid crystal display panel. Of course, the display substrate can also be used directly as a display panel for display, which can enhance color purity by setting a color-resist unit to filter the light emitted from the light-emitting device.

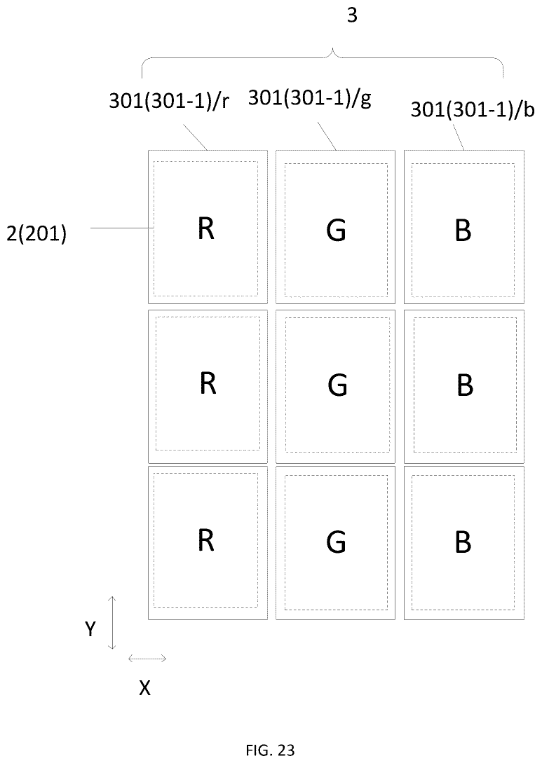

In some embodiments, as shown in FIG. 23, the color-resist units 301 correspond to the sub-pixels 2 in one-to-one correspondence.

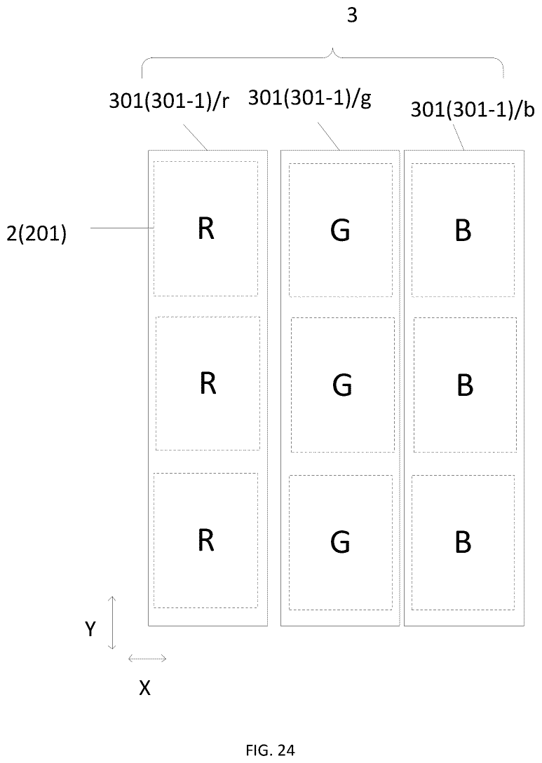

Alternatively, in some embodiments, as shown in FIG. 24, each color-resist unit 301 corresponds to multiple sub-pixels 2 that are continuously arranged and of the same color. As shown in FIG. 24, a column of sub-pixels 2 arranged in the second direction Y have the same color, and each color-resist unit 301 extends along the second direction Y and corresponds to a column of sub-pixels 2 that are arranged in the second direction Y.

When sub-pixels of the same color are arranged consecutively, in the display substrate provided by embodiments of the present disclosures, each color-resist unit corresponds to a plurality of sub-pixels arranged consecutively and of the same color, so that the difficulty in fabricating the color-resist units can be simplified.

It should be noted that FIGS. 23-24 are illustrated with a column of sub-pixels 2 arranged in the second direction Y having the same color as an example, and adjacent sub-pixels in the first direction X have different colors. In specific implementations, adjacent sub-pixels in the second direction Y may also be set to have different colors. In specific implementations, the red sub-pixel R, the blue sub-pixel B, and the green sub-pixel G in FIGS. 23-24 form one pixel, and the red sub-pixel R, the blue sub-pixel B, and the green sub-pixel G are arranged in one row in the first direction X. In specific implementations, the red sub-pixel R, the blue sub-pixel B, and the green sub-pixel G included in a pixel may also be arranged in multiple rows, and two adjacent sub-pixels in one pixel may also be arranged in a staggered manner, such as a line connecting the centers of the two adjacent sub-pixels is not parallel to the first direction and/or not parallel to the second direction. Regardless of the sub-pixel arrangement, the display substrate may include the inorganic color-resist layer provided by embodiments of the present disclosure.

It should be noted that FIGS. 23-24 are illustrated with the shape of the color-resist unit 301 on the base substrate being rectangular as an example. In specific implementation, the shape of the color-resist unit on the base substrate may be set according to the shape of the sub-pixel opening region, for example, the shape of the color-resist unit on the base substrate may match the shape of the sub-pixel opening region on the base substrate. For example, when the shape of the sub-pixel opening region is substantially pentagon, the shape of the color-resist unit on the base substrate may also be set to be pentagon.

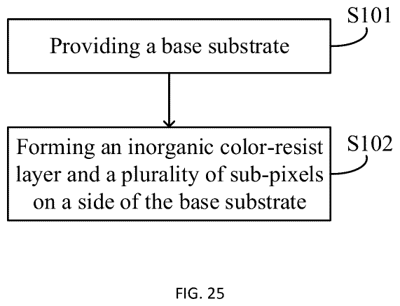

Based on the same inventive concept, the embodiments of the present disclosure also provide a method of fabricating a display substrate, as shown in FIG. 25, including:
S101, providing a base substrate;
S102, forming an inorganic color-resist layer and a plurality of sub-pixels on a side of the base substrate; herein, each sub-pixel of the plurality of sub-pixels includes a sub-pixel opening region; the inorganic color-resist layer includes a plurality of color-resist units; an orthographic projection of a color-resist unit on the base substrate covers an orthographic projection of the sub-pixel opening region on the base substrate, and the plurality of color-resist units include: a first color-resist unit, a second color-resist unit and a third color-resist unit, at least two of the first color-resist unit, the second color-resist unit, and the third color-resist unit have different light emitting colors; the color-resist unit includes at least two inorganic sub-layers that are stacked alternately, the quantity of inorganic sub-layers included in color-resist units with different light emitting colors varies, and refractive indexes of the two adjacent inorganic sub-layers are different.

The method for fabricating a display substrate provided in embodiments of the present disclosure forms an inorganic color-resist layer by alternately stacking at least two inorganic sub-layers, and the inorganic color-resist layer includes a color-resist unit that transmits light in a wavelength range corresponding to the color of a sub-pixel. The color-resist unit formed by stacking the inorganic sub-layers does not absorb light, thereby improving the light utilization rate of the display substrate compared to a conventional absorption type color film. Moreover, since the color-resist unit are stacked with the inorganic sub-layers, it can be patterned using a dry engraving process, and compared to the resin color film of the related art, the size of the color-resist unit can be made smaller, which can increase the pixel density of the display product, and thus the display substrate provided by the embodiments of the present disclosure can be applied to ultra-high pixel density display products, such as Virtual Reality (VR) display products, increasing the application scenarios of the display substrate.

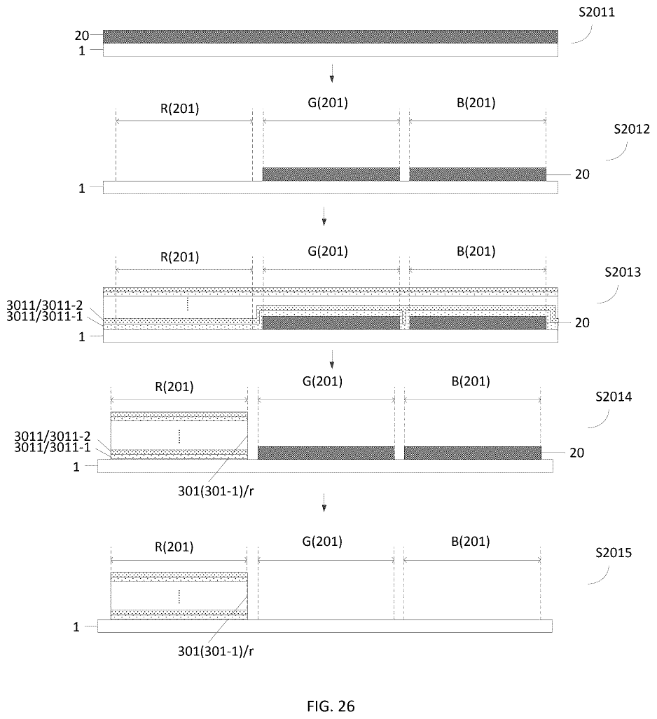

In some embodiments, S102, the forming the inorganic color-resist layer on the side of the base substrate, specifically includes:
as shown in FIGS. 26 to 28, fabricating first portions of color-resist units with different light emitting colors separately, and the first portion included in the color-resist unit for each light emitting color is fabricated using the following steps:
S1021, forming a sacrificial layer 20 on a side of the base substrate 1;
S1022, performing a patterning process on the sacrificial layer 20 to remove the sacrificial layer 20 from a region corresponding to the color-resist unit 301 of the each light emitting color;
S1023, forming a multi-layer inorganic sub-layer 3011;
S1024, performing a patterning process on the multi-layer inorganic sub-layer 3011 to form a plurality of first portions 301-1; and
S1025, removing the sacrificial layer 20.

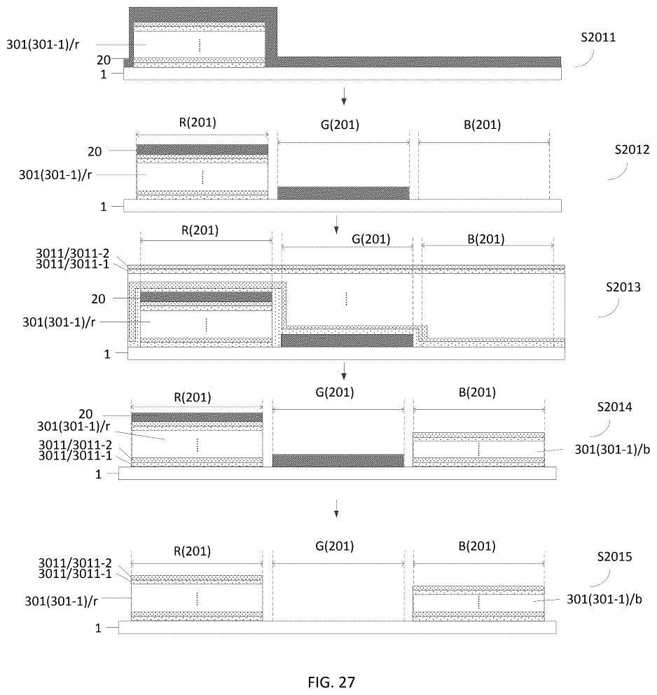

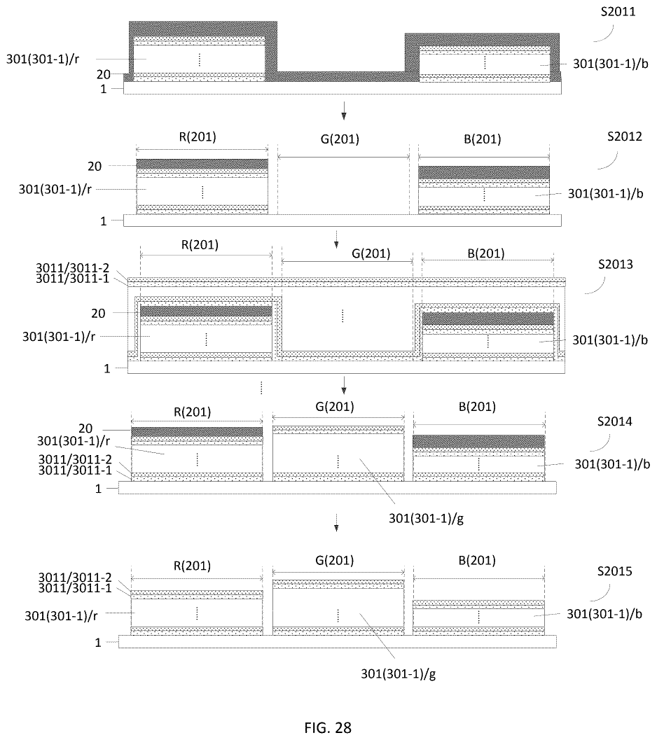

It should be noted that FIG. 26 shows the step of fabricating the first portion 301-1 of the red color-resist unit r, FIG. 27 shows the step of fabricating the first portion 301-1 of the blue color-resist unit b, and FIG. 28 shows the step of fabricating the first portion 301-1 of the green color-resist unit g, i.e., the methods shown in FIGS. 26-28 are used to fabricate the red color-resist unit, the blue color-resist unit, and the green color-resist unit in sequence. Of course, other sequences can be used to fabricate the red color-resist unit, the blue color-resist unit, and the green color-resist unit.

It should be noted that FIGS. 26-28 are illustrated with an example of the side of the first portion 301-1 being perpendicular to the base substrate 1. However, when the first portion is formed using an etching process, due to process limitations, it may occur that the side of the pattern of the first portion has an angle of less than 90° to the base substrate. That is, the lateral surface of the first portion includes an inclined surface.

The method for fabricating the display substrate provided in embodiments of the present disclosure, in which a sacrificial layer is formed first before forming a color-resist unit having the same light emitting color, to protect a film layer below the inorganic color-resist layer. Moreover, removing the sacrificial layer can be done by a dry engraving process, which can avoid causing damage to the already formed inorganic color-resist layer and the film layer below the inorganic color-resist layer.

In specific implementations, the sacrificial layer covers at least the sub-pixel opening region.

In some embodiments, as shown in FIG. 26, the pattern of one sacrificial layer 20 corresponds to one sub-pixel opening region 201.

In specific implementations, when a first portion of a red color-resist unit is fabricated, a portion of the sacrificial layer covers a sub-pixel opening region of a blue sub-pixel, and the remaining portion of the sacrificial layer covers a sub-pixel opening region of a green sub-pixel. When fabricating the first portion of the blue color-resist unit, a portion of the sacrificial layer covers a sub-pixel opening region of a red sub-pixel and the remaining portion of the sacrificial layer covers a sub-pixel opening region of a green sub-pixel. When a first portion of a green color-resist unit is fabricated, a portion of the sacrificial layer covers a sub-pixel opening region of a blue sub-pixel and the remaining portion of the sacrificial layer covers a sub-pixel opening region of a red sub-pixel.

Alternatively, in some embodiments, it may be that the pattern of one sacrificial layer corresponds to a plurality of sub-pixel opening regions.

In specific implementations, performing the patterning process on the multi-layer inorganic sub-layer, including, for example, the steps of: photoresist coating, exposure, development, and dry etching, etc.

In some embodiments, the sacrificial layer is subjected to a patterning process to remove the sacrificial layer in the region corresponding to the color-resist unit of the each light emitting color, specifically including:
using a wet etching process to remove the sacrificial layer in the region corresponding to the color-resist unit of the each light emitting color.

The method for fabricating the display substrate provided by embodiments of the present disclosure may use a wet etching process to remove the sacrificial layer, which may avoid causing damage to the inorganic color-resist layer that has been formed and the film layer below the inorganic color-resist layer, compared to a dry etching process.

In some embodiments, the sacrificial layer includes a metal material.

In specific implementations, the sacrificial layer includes one or a combination of the following: molybdenum, aluminum.

In some embodiments, the thickness of the sacrificial layer is greater than or equal to 100 angstroms and less than or equal to 2000 angstroms.

In some embodiments, after the first portions of the color-resist units with different light emitting colors are fabricated, respectively, the method further includes:
forming second portions of the plurality of color-resist units on one sides of the first portions facing away from the base substrate; the second portions of the plurality of color-resist units being integrally connected.

In some embodiments, before forming the inorganic color-resist layer, the method further includes:
forming a pattern of a first light-shielding part; where an orthographic projection of the first light-shielding part on the base substrate covers a region between orthographic projections of adjacent first portions on the base substrate, and the orthographic projection of the first light-shielding part on the base substrate does not overlap with the orthographic projection of the sub-pixel opening region on the base substrate.

The method for fabricating the display substrate provided by embodiments of the present disclosure provides the first light-shielding part between adjacent first portions and between sub-pixel opening regions, so that light leakage from the region between adjacent sub-pixel opening regions can be avoided, the brightness of the light emitted from the sub-pixel opening regions can be improved, and thus the contrast of the display substrate can be improved. Moreover, the orthographic projection of the first light-shielding part on the base substrate and the sub-pixel opening regions do not overlap with each other, which also prevents the first light-shielding part from blocking the sub-pixel opening regions, and avoids affecting the aperture rate of the sub-pixel.

In some embodiments, the method further includes:
forming a pattern of a superposition portion; where an orthographic projection of the superposition portion on the base substrate covers an orthographic projection of a region between adjacent sub-pixel opening regions on the base substrate, and the orthographic projection of the superposition portion on the base substrate and the orthographic projection of the sub-pixel opening region on the base substrate do not overlap each other.

In some embodiments, the pattern of the superposition portion may be formed after forming the inorganic color-resist layer.

Alternatively, in some embodiments, the pattern of the superposition portion may be formed before forming the inorganic color-resist layer. When the display substrate includes the first light-shielding part, the pattern of the superposition portion may be formed after the pattern of the first light-shielding part is formed, and the inorganic color-resist layer may be formed thereafter.

Alternatively, in some embodiments, the pattern of the superposition portion may be formed while the inorganic color-resist layer is formed.

In some embodiments, the plurality of color-resist units includes a red color-resist unit, a blue color-resist unit, and a green color-resist unit, and the superposition portion corresponding to a red color-resist unit and a green color-resist unit adjacent to each other is a first superposition portion, the superposition portion corresponding to a red color-resist unit and a blue color-resist unit adjacent to each other is a second superposition portion, and the superposition portion corresponding to a green color-resist unit and a blue color-resist unit adjacent to each other is a third superposition portion; the forming the pattern of the superposition portion specifically includes:
forming the pattern of the first superposition portion while forming the first portion of the blue color-resist unit, forming the pattern of the second superposition portion while forming the first portion of the green color-resist unit, and forming the pattern of the third superposition portion while forming the first portion of the red color-resist unit.

In some embodiments, the display substrate is applied to a liquid crystal display, and the display substrate serves as an array substrate for a liquid crystal display panel.

In some embodiments, forming the sub-pixels, specifically includes:
forming a thin film transistor and a pixel electrode.

In some embodiments, before forming the sub-pixels, the method further includes:
forming a buffer layer;

the forming the thin film transistor specifically includes:
forming an active layer, a gate insulation layer, a gate, a first inorganic insulation layer, a source, and a drain in sequence on a side of the buffer layer facing away from the base substrate.

In some embodiments, before forming the thin film transistor, the method further includes:
forming a pattern of a second light-shielding layer on the side of the buffer layer facing away from the base substrate.

In some embodiments, after forming the thin film transistor, the method further includes:
forming a second planarization layer;

the forming the pixel electrode specifically includes:
forming a pattern of the pixel electrode on a side of the second planarization layer facing away from the base substrate.

In some embodiments, after forming the pixel electrode, the method further includes:
forming a first protective layer;
forming a pattern of a common electrode on a side of the first protective layer facing away from the base substrate; and
forming a second protective layer on a side of the common electrode facing away from the base substrate.

In some embodiments, after forming the inorganic color-resist layer, the method further includes:
forming a first planarization layer;

the forming the sub-pixels, specifically includes:
forming a thin film transistor and a pixel electrode sequentially on a side of the first planarization layer facing away from the base substrate.

In specific implementations, forming the first planarization layer specifically includes: coating silicone as the first planarization layer.

Alternatively, in some embodiments, the forming the inorganic color-resist layer and the plurality of sub-pixels on the side of the base substrate specifically includes:
forming a plurality of thin film transistors on the side of the base substrate;
forming the plurality of color-resist units located in the same layer as sources and drains of the thin-film transistors;
forming a first planarization layer on one sides of the color-resist units facing away from the base substrate; and
forming a pixel electrode on a side of the first planarization layer facing away from the base substrate.

Alternatively, in some embodiments, forming the inorganic color-resist layer and the plurality of sub-pixels on the side of the base substrate, specifically includes:
forming a plurality of thin film transistors and a plurality of pixel electrodes on the side of the base substrate; and
forming the inorganic color-resist layer on one sides of the pixel electrodes facing away from the base substrate.

In some embodiments, when the display substrate includes a common electrode, forming the inorganic color-resist layer on one sides of the pixel electrodes facing away from the base substrate specifically includes:

forming the inorganic color-resist layer on the side of the second protective layer facing away from the base substrate.

Alternatively, the display substrate is applied to an electroluminescent display.

In some embodiments, forming the inorganic color-resist layer and the plurality of sub-pixels on the side of the base substrate, specifically includes:
forming a plurality of light-emitting devices on the side of the base substrate; and
forming the inorganic color-resist layer on one sides of the plurality of light-emitting devices facing away from the base substrate.

In some embodiments, forming the light-emitting devices specifically includes: forming an anode, a light-emitting functional layer, and a cathode.

In some embodiments, before forming the light-emitting device, the method further includes:
forming a pixel driving circuit; where the pixel driving circuit includes a thin film transistor and a capacitor.

In some embodiments, after forming the anode and before forming the light-emitting functional layer, the method further includes:
forming a pattern of a pixel-defining layer; where the pixel-defining layer includes a first opening region, an orthographic projection of the first opening region on the base substrate falls within an orthographic projection of the anode on the base substrate.

Based on the same inventive concept, the embodiments of the present disclosure also provide a display apparatus, the display apparatus includes the display substrate provided by embodiments of the present disclosure.

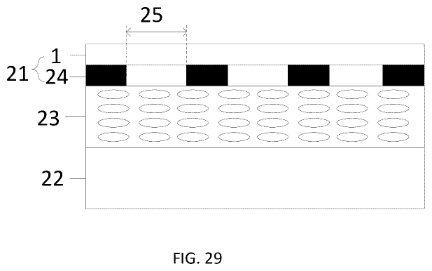

In specific implementations, the display apparatus may be a liquid crystal display apparatus, and in some embodiments, as shown in FIG. 29, the display apparatus further includes:
an opposite substrate 21, arranged opposite the display substrate 22; and
a liquid crystal layer 23, located between the display substrate 22 and the opposite substrate 21.

It should be noted that in the display apparatus provided by the embodiments of the present disclosure, the display substrate, the liquid crystal layer, and the opposite substrate form a liquid crystal display panel, and the opposite substrate does not need to be provided with a color film. In specific implementations, as shown in FIG. 29, the opposite substrate 21 includes a base substrate 1 and a black matrix 24 located at a side of the base substrate 1 facing the liquid crystal layer 23; the black matrix 24 is provided with a plurality of second opening regions 25, the second opening regions 25 correspond one-to-one with the sub-pixel opening regions. The display apparatus provided by the embodiments of the present disclosure, since the display substrate includes a color-resist unit, it is not necessary to provide a color film located in the second opening area for the opposite substrate.

In specific implementations, the orthographic projection of the black matrix on the base substrate needs to cover the orthographic projection of the data line on the base substrate. For a display product with high resolution, the line width of the data line is small. For example, for the display product with a resolution of 1200 PPI, the line width of the data line is greater than or equal to 1.2 microns and less than or equal to 2 microns, and in a direction perpendicular to the extension direction of the data line, the line width of the black matrix is greater than or equal to 2.5 microns and less than or equal to 3.5 microns. For display products with a resolution of 1500 PPI, the line width of the data line is greater than or equal to 1 micron and less than or equal to 1.8 microns, and the line width of the black matrix is greater than or equal to 1 micron and less than or equal to 1.8 microns in the direction perpendicular to the extension direction of the data line. For display products with a resolution greater than 2000 PPI, the line width of the data line is greater than or equal to 1 micron and less than or equal to 1.5 microns, and in the direction perpendicular to the extension direction of the data line, the line width of the black matrix is greater than or equal to 1.5 microns and less than or equal to 2.5 microns.

In some embodiments, the display apparatus further includes:
a backlight module; the display substrate is located at a light-emitting side of the backlight module.

In some embodiments, the backlight module may also include a display substrate provided by embodiments of the present disclosure, i.e., the display substrate serves as a backlight source of the backlight module.

The display apparatus provided by the embodiments of the present disclosure is: a cell phone, a tablet computer, a television, a monitor, a laptop computer, a digital photo frame, a navigator, and any other product or component having a display function. Other essential components of the display apparatus are understood by those of ordinary skill in the art, and are not described herein, nor should they be taken as limitations on the present disclosure. The implementation of the display apparatus can be seen in the above embodiments of array substrates and display panels, and will not be repeated.

In summary, the display substrate provided by embodiments of the present disclosure includes a color-resist unit that is provided by alternately stacking at least two inorganic sub-layers, such that the color-resist unit transmits light in a wavelength range corresponding to the color of a sub-pixel. The color-resist unit formed by stacking the inorganic sub-layers does not absorb light, thereby improving the light utilization rate of the display substrate compared to a conventional absorption-type color film. Moreover, since the color-resist unit are stacked with inorganic sub-layers, it can be patterned using a dry engraving process, and the size of the color-resist unit can be made smaller compared to the resin color film of the prior art, which can increase the pixel density of the display product, and thus the display substrate provided by the embodiments of the present disclosure can be applied to display products with ultra-high pixel density, for example, it can be applied to VR display products, which increases the application scenarios of the display substrate.

Although the preferred embodiments of the present disclosure have been described, those skilled in the art will be able to make additional changes and modifications to these embodiments once the basic inventive concepts are apparent. Therefore, it is intended that the appended claims be construed to include the preferred embodiments and all changes and modifications that fall within the scope of the present disclosure.

Obviously, those skilled in the art can make various changes and modifications to the embodiments of the present disclosure without departing from the spirit and scope of the embodiments of the present disclosure. In this way, if these modifications and variations of the embodiments of the present disclosure fall within the scope of the claims of the present disclosure and equivalent technologies, the present disclosure is also intended to include these modifications and variations.

1. A display substrate, comprising:
a base substrate;
a plurality of sub-pixels, located on a side of the base substrate; wherein each of the plurality of sub-pixels comprises a sub-pixel opening region; and
an inorganic color-resist layer, located on a same side of the base substrate as the plurality of sub-pixels and comprising a plurality of color-resist units;
wherein an orthographic projection of a color-resist unit on the base substrate covers an orthographic projection of the sub-pixel opening region on the base substrate,
the plurality of color-resist units comprises a first color-resist unit, a second color-resist unit and a third color-resist unit, and at least two of the first color-resist unit, the second color-resist unit and the third color-resist unit have different light emitting colors; and
the color-resist unit comprises at least two inorganic sub-layers that are stacked alternately, a quantity of inorganic sub-layers comprised in color-resist units with different light emitting colors varies, and refractive indexes of two adjacent inorganic sub-layers are different.

2. The display substrate according to claim 1, wherein at least two of the first color-resist unit, the second color-resist unit and the third color-resist unit have different thicknesses in a direction perpendicular to the base substrate.

3. The display substrate according to claim 2, wherein a difference in thicknesses of different color-resist units in the direction perpendicular to the base substrate is less than or equal to 1 micron.

4. The display substrate according to claim 2, wherein the color-resist unit comprises a first portion; and first portions of different color-resist units are provided independently of each other;
wherein an absolute value of a distance between first portions of different color-resist units adjacent to each other is less than or equal to 10 microns
wherein the absolute value of the distance between first portions of different color-resist units adjacent to each other is less than or equal to 3 microns.

5. (canceled)

6. (canceled)

7. The display substrate according to claim 4, wherein the color-resist unit further comprises a second portion located at a side of the first portion facing away from the base substrate, and second portions of the plurality of color-resist units are integrally connected;
wherein first portions of at least two of the first color-resist unit, the second color-resist unit and the third color-resist unit have different thicknesses in the direction perpendicular to the base substrate.

8. (canceled)

9. The display substrate according to claim 4, wherein the display substrate further comprises:
a first light-shielding part, located between the first portion and the base substrate; wherein an orthographic projection of the first light-shielding part on the base substrate covers an region between orthographic projections of adjacent first portions on the base substrate, and the orthographic projection of the first light-shielding part on the base substrate does not overlap the sub-pixel opening region.

10. The display substrate according to claim 4, wherein a lateral surface of the first portion comprises an inclined surface, and an included angle between the inclined surface and a plane where the base substrate is located is greater than or equal to 60° and less than 90°.

11. The display substrate according to claim 10, wherein an absolute value of a minimum distance between inclined surfaces of two adjacent first portions is less than or equal to 5 microns.

12. The display substrate according to claim 10, wherein in a region between adjacent sub-pixel opening regions, orthographic projections of adjacent first portions on the base substrate have an overlap; and
an orthographic projection of the first portion on the base substrate does not overlap an orthographic projection, on the base substrate, of a sub-pixel opening region corresponding to an adjacent first portion of the first portion.

13. The display substrate according to claim 12, wherein,
an orthographic projection of any first portion on the base substrate covers an orthographic projection of a region between adjacent sub-pixel opening regions on the base substrate;
the inorganic color-resist layer further comprises a superposition portion; wherein an orthographic projection of the superposition portion on the base substrate covers the orthographic projection of the region between adjacent sub-pixel opening regions on the base substrate, and the orthographic projection of the superposition portion on the base substrate and the orthographic projection of the sub-pixel opening region on the base substrate do not overlap each other; and
between the adjacent sub-pixel opening regions, the orthographic projection of the color-resist unit on the base substrate and the orthographic projection of the superposition portion on the base substrate have an overlapping region in which a light transmittance is less than 5%;
wherein a surface of the first portion on a side away from the base substrate comprises a first planar region, and an orthographic projection of the first planar region on the base substrate covers the sub-pixel opening region.

14. (canceled)

15. The display substrate according to claim 1, wherein the color-resist unit comprises a first inorganic sub-layer and a second inorganic sub-layer; wherein a refractive index of the first inorganic sub-layer is greater than a refractive index of the second inorganic sub-layer; and an inorganic sub-layer closest to the base substrate is the first inorganic sub-layer;
wherein a material of the first inorganic sub-layer comprises one or a combination of following: silicon nitride, titanium dioxide, titanium pentoxide, niobium pentoxide, zirconium dioxide, yttrium trioxide, and zinc sulfide; and
a material of the second inorganic sub-layer comprises one or a combination of following: silicon oxide, and magnesium fluoride.

16. (canceled)

17. The display substrate according to claim 1, wherein the sub-pixel comprises: a thin-film transistor, and a pixel electrode located at a side of the thin-film transistor facing away from the base substrate.

18. The display substrate according to claim 17, wherein the inorganic color-resist layer is located between the base substrate and the plurality of sub-pixels;
wherein the display substrate further comprises: a first planarization layer between the inorganic color-resist layer and the plurality of sub-pixels;
wherein a material of the first planarization layer comprises organic silicone.

19. (canceled)

20. The display substrate according to claim 17, wherein the inorganic color-resist layer is located between the thin film transistor and the pixel electrode; wherein,
the thin film transistor comprises: a gate, a source and a drain;
the display substrate further comprises: a first inorganic insulation layer between the gate and the source and drain, and a second planarization layer between the source and drain and the pixel electrode; and
the inorganic color-resist layer is located between the first inorganic insulation layer and the second planarization layer;
wherein a material of the second planarization layer comprises a resin.

21. (canceled)

22. (canceled)

23. The display substrate according to claim 17, wherein the inorganic color-resist layer is located at one sides of the plurality of sub-pixels facing away from the base substrate;
wherein each sub-pixel comprises a light-emitting device; and the inorganic color-resist layer is located at a side of the light-emitting device facing away from the base substrate-;
wherein the plurality of color-resist units and the plurality of sub-pixels are in one-to-one correspondence;
wherein each color-resist unit corresponds to multiple sub-pixels arranged continuously and of a same color;
wherein the plurality of sub-pixels comprise: a plurality of red sub-pixels, a plurality of green sub-pixels, and a plurality of blue sub-pixels;
the first color-resist unit is a red color-resist unit corresponding to a red sub-pixel, the second color-resist unit is a green color-resist unit corresponding to a green sub-pixel, and the third color-resist unit is a blue color-resist unit corresponding a blue sub-pixel; and
in the direction perpendicular to the base substrate, a thickness of the red color-resist unit is greater than a thickness of the blue color-resist unit, and a thickness of a green color-resist unit is greater than the thickness of the red color-resist unit.

24. (canceled)

25. (canceled)

26. (canceled)

27. (canceled)

28. A method for fabricating a display substrate, comprising:
providing a base substrate;
forming an inorganic color-resist layer and a plurality of sub-pixels on a side of the base substrate;
wherein each of the plurality of sub-pixels comprises a sub-pixel opening region; the inorganic color-resist layer comprises a plurality of color-resist units; an orthographic projection of a color-resist unit on the base substrate covers an orthographic projection of the sub-pixel opening region on the base substrate, and the plurality of color-resist units comprise: a first color-resist unit, a second color-resist unit and a third color-resist unit, and at least two of the first color-resist unit, the second color-resist unit and the third color-resist unit have different light emitting colors; the color-resist unit comprises at least two inorganic sub-layers that are stacked alternately, a quantity of inorganic sub-layers comprised in color-resist units with different light emitting colors varies, and refractive indexes of two adjacent inorganic sub-layers are different.

29. The method according to claim 28, wherein the forming the inorganic color-resist layer on the side of the base substrate, further comprises:
fabricating first portions of color-resist units with different light emitting colors separately;
wherein a first portion comprised in the color-resist unit for each light emitting color is fabricated by following steps:
forming a sacrificial layer on the side of the base substrate, wherein the sacrificial layer comprises a metal material;
performing a patterning process on the sacrificial layer to remove the sacrificial layer from a region corresponding to the color-resist unit of the each light emitting color;
forming a multi-layer inorganic sub-layer;
performing a patterning process on the multi-layer inorganic sub-layer to form patterns of the first portions; and
removing the sacrificial layer.

30. The method according to claim 29, wherein the performing the patterning process on the sacrificial layer to remove the sacrificial layer from the region corresponding to the color-resist unit of the each light emitting color, further comprises:
removing the sacrificial layer from the region corresponding to the color-resist unit of the each light emitting color by using a wet etching process.

31. The method according to claim 29, after fabricating the first portions of the color-resist units with different light emitting colors separately, further comprising:
forming second portions of the plurality of color-resist units on one sides of the first portions facing away from the base substrate; wherein the second portions of the plurality of color-resist units are integrally connected;
wherein, before forming the inorganic color-resist layer, the method further comprises:
forming a pattern of a first light-shielding part; wherein an orthographic projection of the first light-shielding part on the base substrate covers an region between orthographic projections of adjacent first portions on the base substrate, and the orthographic projection of the first light-shielding part on the base substrate and the sub-pixel opening region do not overlap each other.

32. (canceled)

33. A display apparatus, comprising a display substrate, wherein the display substrate comprises:
a base substrate;
a plurality of sub-pixels, located on a side of the base substrate; wherein each of the plurality of sub-pixels comprises a sub-pixel opening region; and
an inorganic color-resist layer, located on a same side of the base substrate as the plurality of sub-pixels and comprising a plurality of color-resist units;
wherein an orthographic projection of a color-resist unit on the base substrate covers an orthographic projection of the sub-pixel opening region on the base substrate,
the plurality of color-resist units comprises a first color-resist unit, a second color-resist unit and a third color-resist unit, and at least two of the first color-resist unit, the second color-resist unit and the third color-resist unit have different light emitting colors; and
the color-resist unit comprises at least two inorganic sub-layers that are stacked alternately, a quantity of inorganic sub-layers comprised in color-resist units with different light emitting colors varies, and refractive indexes of two adjacent inorganic sub-layers are different.
